(19) United States
(12) Patent Application Publication
(10) Pub. No.: US 2021/0277684 A1
(43) Pub. Date: Sep. 9, 2021

(54) DOUBLE LATCH LOCKSET

(71) Applicant: Townsteel, Inc., City of Industry, CA (US)

(72) Inventors: Charles W. Moon, Colorado Springs, CO (US); Sybor Ma, La Puente, CA (US); Chad P. Moon, Colorado Springs, CO (US)

(21) Appl. No.: 17/147,325

(22) Filed: Jan. 12, 2021

Related U.S. Application Data
(63) Continuation-in-part of application No. 15/393,679, filed on Dec. 29, 2016, now Pat. No. 10,890,020.
Application No. 15/393,679 is a continuation-in-part of application No. 15/393,712, filed on Dec. 29, 2016.
Application No. 15/393,712 is a continuation-in-part of application No. 17/093,534, filed on Nov. 9, 2020.

(51) Int. Cl. E05B 55/00; E05B 59/00; E05B 9/02

(52) U.S. Cl. CPC E05B 55/005; E05B 9/02; E05B 59/00

(57) ABSTRACT

A lockset enables motion of an outside door handle in one direction to retract a latchbolt and motion of the outside door handle in an opposite direction to lock the deadbolt, and optionally also the latchbolt. The lockset then requires a key, code, or other credential to re-enter, unless another opens or unlocks the door from the inside. The ability to deadbolt the door from the outside makes it faster to secure a building or enclosure after exiting it.

### RELATED APPLICATIONS

This application is a continuation-in-part of U.S. Pat. No. 10,890,020, issued Jan. 12, 2021, entitled “Double Latch Lockset,” which is herein incorporated by reference for all purposes. This application is also a continuation-in-part of U.S. patent application Ser. No. 15/393,712, filed Dec. 29, 2016, entitled “Sliding Actuator Assembly for a Latchset,” which is herein incorporated by reference for all purposes. This application is also a continuation in part of U.S. patent application Ser. No. 17/093,534, filed Nov. 9, 2020, entitled “Lockset with Sliding Spindle,” which is herein incorporated by reference for all purposes.

### TECHNICAL FIELD

The present disclosure generally relates to double latch locksets, including kits and methods for manufacturing double latch locksets.

### BACKGROUND

Doors are often installed with two latches. The first is typically a retractable latch, and the second is typically a deadbolt that provides greater security. However, manufacturers found that in cases where both latches were latched and room occupants panicked while trying to exit, the action of manually unlocking both latches was difficult. Single action, double bolt release locksets were developed to allow occupants to turn one doorknob or lever and unlatch both bolts.

Since that time, changes have been made to individual types of latches and to mechanisms that might connect one latch to another.

However, there is need in the art for a double latch lockset that improves convenience, efficiency, and safety.

### SUMMARY

A lockset comprises a latchbolt, a deadbolt, a main spindle, and a spindle-operated latch-retracting assembly. The lockset also has a lock actuator configured with an unlocking maneuver to retract the deadbolt and a deadbolt-operating link assembly. When the lockset is assembled, the deadbolt-operating link assembly couples the deadbolt to the main spindle and transfers motion of the outside handle in a first direction to project the deadbolt. After the deadbolt is projected and the outside handle is released, the link assembly is ineffective to transfer motion of the outside handle in the second direction to retract the deadbolt until the deadbolt is reset by action other than a mere movement of the outside handle.

Other systems, devices, methods, features, and advantages of the disclosed product, kits, and methods for forming a double latch lockset and parts of locksets will be apparent or will become apparent to one with skill in the art upon examination of the following figures and detailed description. All such additional systems, devices, methods, features, and advantages are intended to be included within the description and to be protected by the accompanying claims.

### BRIEF DESCRIPTION OF THE DRAWINGS

The present disclosure may be better understood with reference to the following figures. Corresponding reference numerals designate corresponding parts throughout the figures, and components in the figures are not necessarily to scale.

It will be appreciated that the drawings are provided for illustrative purposes and that the invention is not limited to the illustrated embodiment. For clarity and in order to emphasize certain features, not all of the drawings depict all of the features that might be included with the depicted embodiment. The invention also encompasses embodiments that combine features illustrated in multiple different drawings; embodiments that omit, modify, or replace some of the features depicted; and embodiments that include features not illustrated in the drawings.

Therefore, it should be understood that there is no restrictive one-to-one correspondence between any given embodiment of the invention and any of the drawings

FIG. 1 illustrates a double latch lockset.

FIGS. 2 and 3 illustrate the double latch lockset of FIG. 1 with an electronic deadbolt actuator.

FIG. 4 is an exploded view of the double latch lockset of FIG. 2.

FIG. 5 is an exploded view of the double latch lockset of FIG. 3.

FIG. 6 is a front perspective view of a cartridge.

FIG. 7 is an exploded view of the cartridge of FIG. 6, with drive assembly.

FIG. 8 is a rear perspective view of the cartridge of FIG. 6.

FIG. 9 is a rear view of an assembled drive assembly.

FIG. 10 is an exploded view of the cartridge of FIG. 8, with drive assembly.

FIG. 11 is an exploded rear perspective view of a drive assembly and other inner trim.

FIG. 12 is a rear view of FIG. 11 as assembled.

FIG. 13 is an exploded view of the drive assembly of FIG. 11.

FIG. 14 is a front view the inner trim of FIG. 12, as seen from inside a room.

FIG. 15 is a side view cross-section of the inner trim of FIG. 14 comprising a drive assembly.

FIG. 16 illustrates the drive assembly of FIGS. 13-14 when the lockset's lower latch and deadbolt are in normal unlocked position, with the deadbolt retracted.

FIG. 17 illustrates the drive assembly of FIGS. 13-14 when the lockset's lower lever is up, with the lower latch retaining its position and the deadbolt projected.

FIG. 18 illustrates the drive assembly of FIGS. 13-14 when the lockset's lower latch and deadbolt are in normal locked position.

FIG. 19 illustrates the drive assembly of FIGS. 13-14 when the lockset's lower lever is down and both the latch and deadbolt are retracted

FIG. 20 illustrates the assembly of FIGS. 13-14 with the deadbolt blocked during retraction.

FIG. 21 illustrates the assembly of FIGS. 13-14 with the deadbolt blocked during projection.

FIG. 25 is a front perspective view of a cartridge.

FIG. 26 is an exploded view of the cartridge of FIG. 25, with drive assembly.

FIG. 27 is a rear perspective view of the cartridge of FIG. 25.

FIG. 28 is an exploded view of the cartridge of FIG. 27, with drive assembly.

FIG. 29 is an exploded front perspective view of a drive assembly.

FIG. 30 is a rear exploded view of the drive assembly of FIG. 29.

FIG. 31 is a rear view of an assembled drive assembly.

FIG. 32 is a side view cross-section of the drive assembly of FIG. 31.

FIG. 33 is a perspective view of a sliding spindle lockset mechanism.

FIG. 34 is an exploded perspective view of the sliding spindle lockset mechanism.

FIG. 35 is a front view of a double latch lockset incorporating the sliding spindle lockset mechanism.

FIG. 36 is a cross sectional view along line A-A of FIG. 35.

FIG. 37A is a perspective view of a barrel cam, two of which are used in the sliding spindle lockset mechanism.

FIG. 37B is another perspective view of the barrel cam.

FIG. 38A is a top end view of a barrel cam follower incorporated into the button cylinder side of the sliding spindle lockset mechanism.

FIG. 38B is a perspective view of the barrel cam follower of FIG. 38A

FIG. 38C is another perspective view of the barrel cam follower of FIG. 38A

FIG. 39A is a perspective view of a barrel cam follower incorporated into the key cylinder side of the sliding spindle lockset mechanism.

FIG. 39B is a side view of the barrel cam follower of FIG. 39A.

FIG. 39C is a top view of the barrel cam follower of FIG. 39A

FIG. 40 is an exploded perspective view of a double latch lockset incorporating the sliding spindle lockset mechanism of FIG. 33.

FIG. 41A is a side plan view of the sliding lockset mechanism with both the key cylinder and the thumbturn in horizontal positions.

FIG. 41B is an axial view, from the inside, of the sliding lockset mechanism when the outside handle is not engaged with the main spindle.

FIG. 41C is a cross sectional view of the sliding lockset mechanism along line B-B of FIG. 41B, wherein the spindle is disengaged from the cam follower on the key-cylinder side of the mechanism.

FIG. 42A is a side plan view of the sliding lockset mechanism with the key cylinder in a turned position for gaining entry and the thumbturn in a horizontal position.

FIG. 42B is an axial view, from the inside, of the sliding lockset mechanism when the outside handle is engaged to the main spindle by a key turn.

FIG. 42C is a cross sectional view of the sliding lockset mechanism along line B-B of FIG. 42B, wherein the spindle is shifted to the left by the key-cylinder side barrel cam and follower into engagement with the cam follower on the key-cylinder side of the mechanism.

FIG. 43A is a side plan view of the sliding lockset mechanism with the key cylinder in a horizontal position and the thumbturn in an approximately vertical position, realizing a passageway function in which access from the outside is permitted.

FIG. 43B is an axial view, from the inside, of the sliding lockset mechanism when the handle is engaged to the main spindle by the twist button.

FIG. 43C is a cross sectional view of the sliding lockset mechanism along line B-B of FIG. 43B, wherein the spindle is shifted to the right by the button-cylinder side barrel cam and follower into engagement with the cam follower on the button-cylinder side of the mechanism.

FIG. 44 is a state machine that illustrates the functions of the double lock lockset of FIG. 40.

FIG. 45 shows an enlarged view of a handle coupler and spindle driver of FIG. 40.

FIG. 46 illustrates an alternative main spindle and key-cylinder side barrel cam follower in which the male insert and female receiver are swapped.

### DETAILED DESCRIPTION

Prefatory Remarks

Any reference to “invention” within this document is a reference to an embodiment of a family of inventions, with no single embodiment including features that are necessarily included in all embodiments, unless otherwise stated. Furthermore, although there may be references to “advantages” provided by some embodiments, other embodiments may not include those same advantages, or may include different advantages. Any advantages described herein are not to be construed as limiting to any of the claims.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

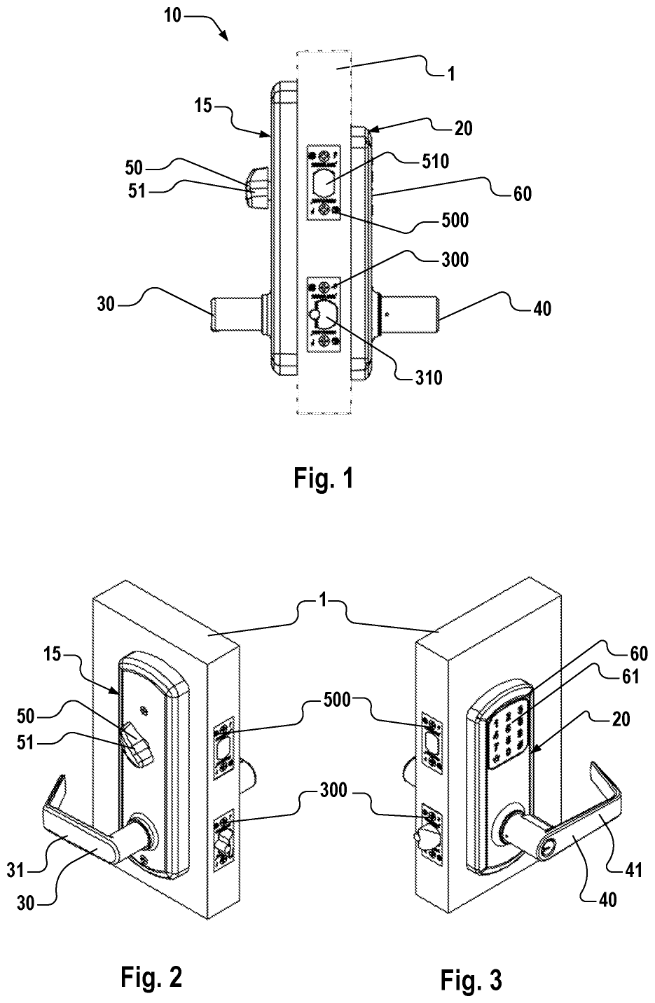

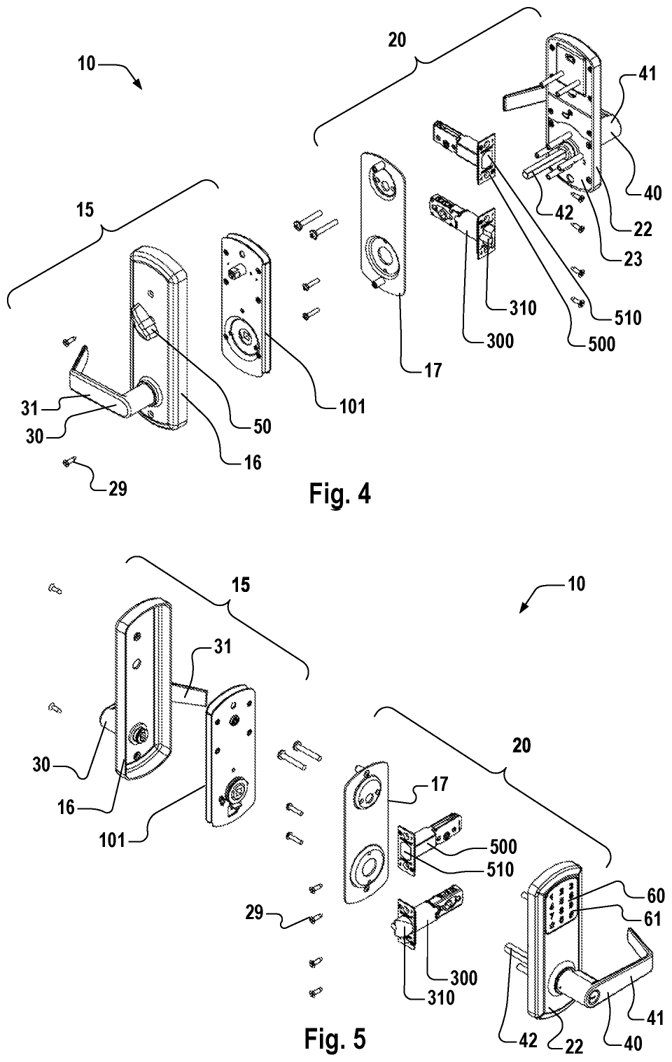

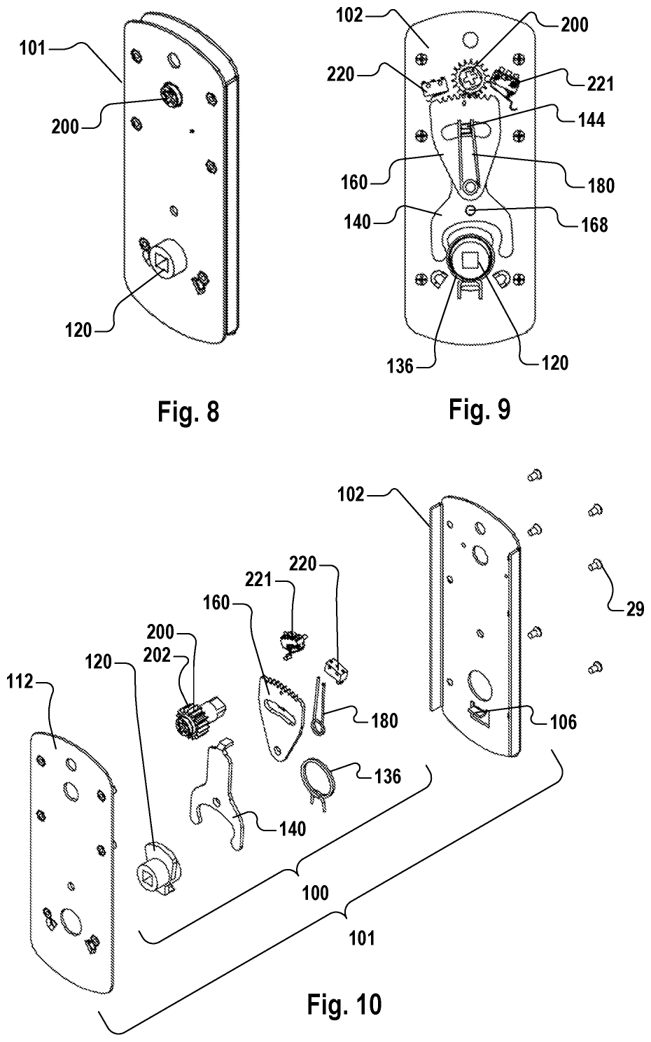

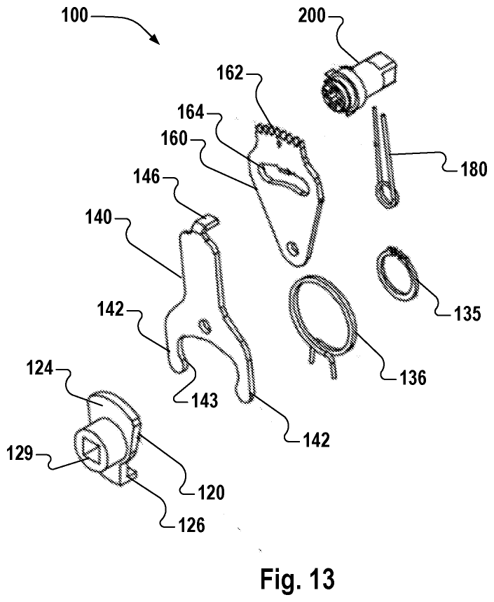

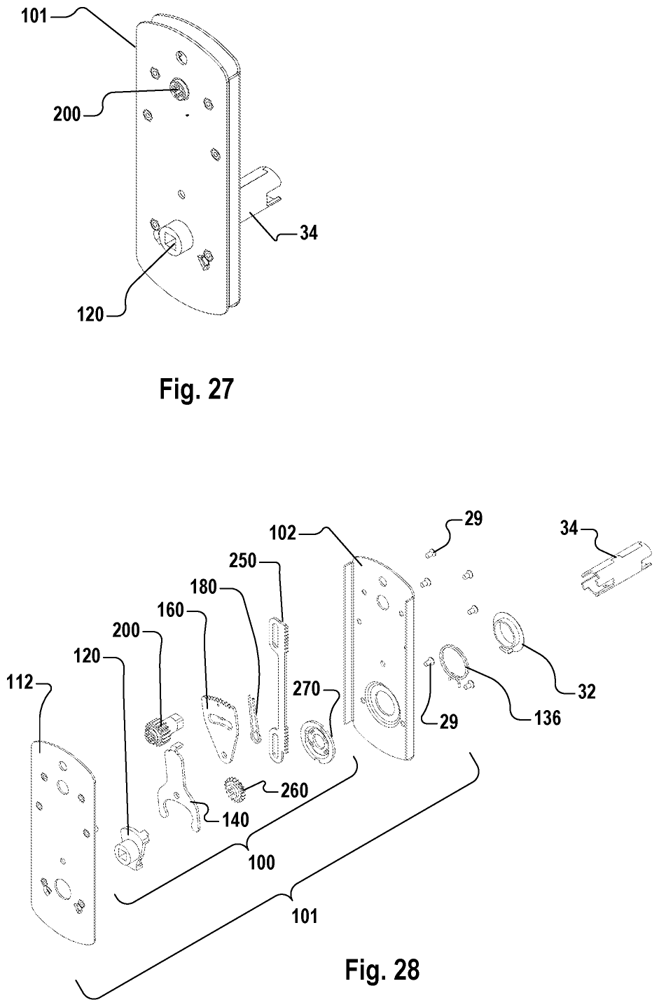

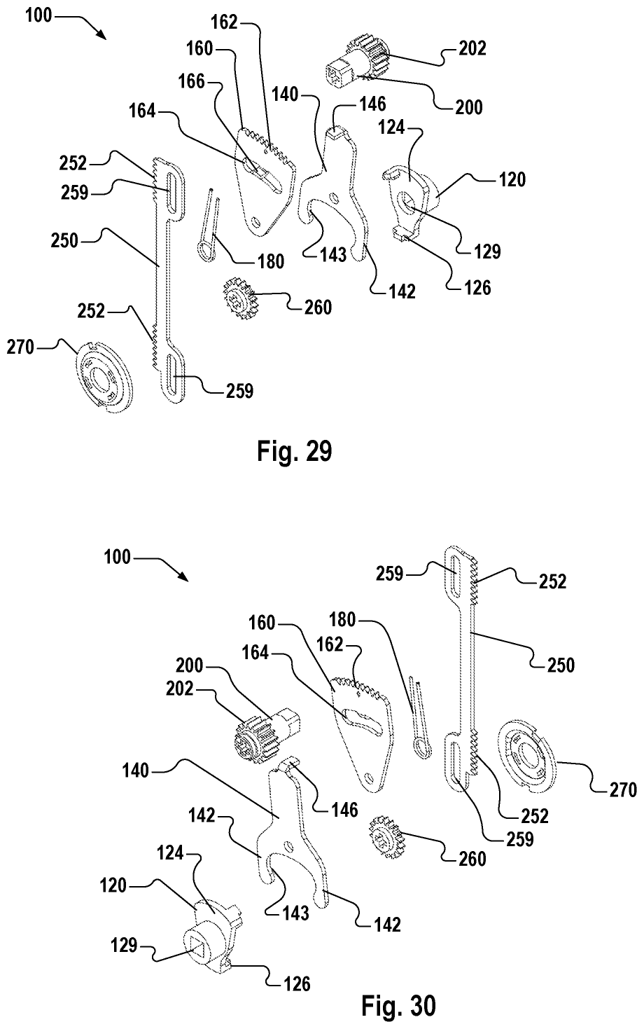

In describing preferred and alternate embodiments of the technology described herein, as illustrated in FIGS. 1-46, specific terminology is employed for the sake of clarity. The technology described herein, however, is not intended to be limited to the specific terminology so selected, and it is to be understood that each specific element includes all technical equivalents that operate in a similar manner to accomplish similar functions.

Some references make a distinction between “locking” and “clutching” mechanisms, with the former referring to a mechanism that blocks an outside handle from rotating and the latter referring to a mechanism that allows the outside handle to turn freely, but without engaging the lockset to retract the latch. In this specification, “locking” is used for convenience to refer to both of these mechanisms, because the result is the same and, ultimately, the bolt or bolts perform a blocking function for either of the two above-mentioned mechanisms. Should a distinction be warranted in some context, then that context will qualify “locking” with additional words to specify a blocking-type lock.

To distinguish between the inside and outside of the access-restricted space, usual terms such as “inside” (or “inner” or “interior”) and “outside” (or “outer” or “exterior”) or “ingress” and “egress” are used in a loose sense in the specification and claims. The use of the foregoing terms in this specification is not limited to installations in doors in which one side is “inside” a structure and one side is “outside” that structure. Rather, in this specification, “inside” and “outside” are relative functional terms assigned two sides of the lockset. More specifically, the “inside” of a door in which the lockset installed is the side for which the lockset imposes the fewest potential requirements to open the door—for example, no key, code or credential required. By contrast, the “outside” of the lockset means either a side that, at least in a locked configuration, restricts passage without use of a key, code, credential, or secret knowledge to pass through.

There are contexts in which the least restrictive access to open the door is provided on what would colloquially be considered the “outside.” Examples include psychiatric hospital safe rooms and prisons. In these corner cases, references to “inside” and “outside”—unless expressly qualified otherwise—should be referred to oppositely of their colloquial meanings. As used in this specification, “inside” and “outside” are to be functionally—not structurally understood.

In contexts where “inside” and “outside” would be undefined—because, for example, equal restrictions and control are applied to both sides of the lockset, or which side is more restrictive is undefined—“inside” and “outside” can refer to either actual side of the fence or other partition whose access is controlled.

In the specification, mention is made of the “rotational equivalent”—using a knob for example—of pulling up a lever-type handle on a door. Whether clockwise or counterclockwise is the “rotational equivalent” depends on context, for example, is a right hand or left hand door, which side of the door for which you are turning the knob, and whether the lever extends from the bore hole toward the center of the door (this is conventional) or from the bore hole (aka lockset bore) toward the nearest edge of the door. If one were to pull up a conventionally installed lever handle on the inside of a left-hand door, for example, this would be equivalent to counterclockwise rotation of a knob that replaced the lever handle. Contrariwise, if the lever were installed in the conventional direction on the outside of the door, the equivalent rotational direction would be clockwise. In an embodiment described herein, the “rotational equivalent” also depends on the direction in which the ramps of certain cams descend.

It will be observed that the embodiments disclosed below collectively provide several lock functions. These include an indoor deadbolt locking function wherein movement of a connected inside door handle in a first direction from a neutral main position to a first extent projects a deadbolt, consistent with ANSI/BHMA A156.2 (applying to Cylindrical (Bored) Pre-Assembled Locks and Latches) or ANSI/BHMA A156.13 (applying to Mortise Locks and Latches). These functions also include an indoor panic-exit function (F88 or F09). Specifically, movement of the connected inside door handle in a second direction opposite the first direction from the neutral main position to a second extent retracts both the deadbolt and a latchbolt. The lockset has an inside door handle button whose positions select between a passageway function in which the outside door handle is operable to retract the latchbolt and a lock function in which the outside door handle is inoperable to retract the latch. The neutral main position is the position of the inside door handle, which is spring-biased, when no external force is exerted on the outside door handle to retract the latch. In the neutral main position, the latchbolt is projected and wherein movement of the inside door handle from the first or second extent to the neutral main position leave the deadbolt in a position it had immediately before said movement.

In this specification, as in common use, the term “latch” may, unless otherwise specified, refer to a single lockset (including its actuators), a latch assembly within a lockset (i.e., a retractable latch or a deadbolt), and/or the bolt component of a latch assembly. “Deadbolt” and “bolt” may likewise have overlapping meanings. Clarity is an objective of this specification; however, clarity is not intended to limit understandable substitutions of terms.

The embodiments described below are illustrative and intended to satisfy the descriptiveness and enablement requirements of 35 U.S.C. 112. It will be understood that the invention is not restrictively defined by the embodiments shown, but rather—and only to the extent—that the claims require them. Other embodiments of the invention include select combinations of elements from two or more of the disclosed embodiments.

Description of Embodiments Derived from patent application Ser. No. 15/393,679

Described below are embodiments of a double latch lockset and kits and methods for making a double latch lockset. Emphasis is placed on interconnectivity between two latches within a lockset, with connecting assemblies providing functionality including simultaneous retraction of two latches, oppositely activated latch projection and/or locking, and other improvements on double latch locksets.

FIGS. 1-5 illustrate that such double latch locksets 10 and kits for installation on a door 1 generally include an interior trim 15, an exterior trim 20, a latchbolt assembly 300, and a deadbolt assembly 500. The interior trim 15 may include a housing called a cartridge 101 for a drive assembly 100 (FIG. 7)—sandwiched between the interior trim's 15 cover 16 and back plate 17 (FIG. 12)—that connects the latchbolt 310 to the deadbolt 510. Thus the drive assembly 100 may also be called a connecting assembly, transmission assembly, or a transfer assembly. The outer trim 20 may include an outer cover 22 and a back plate 23. A tailpiece 42 may be configured to extend from the first exterior handle 40 to the first interior handle 30 and be operable to act on the latchbolt 310. The tailpiece 42 may be called a spindle.

The latchbolt 310 may be activated by a first inside actuator 30 and/or a first outside actuator 40. The first inside and outside actuators 30, 40 may be handles 31, which may be knobs, levers 31, or other actuators. In this specification, handle and lever 31 are used interchangeably, as a lever 31 makes understanding of the product's functionality more straightforward. However, movement of the first inside and outside actuators 30, 40 may be rotary or linear. Reference to movement in a first direction and a second direction are presented generally and as examples unless otherwise explicitly limited. (For example, moving a lever 31 up on the inside will also move the outside lever 31 up. Likewise, moving a knob counterclockwise inside will move a knob outside clockwise. In either case, the lever or knob's movement moves in a first or second direction.) It should be noted that knobs or levers 31 are a mechanical extension of the first and second inside actuators 30, 40, and therefore can be characterized as a component of those actuators.

The deadbolt 510 is activated by a second inside actuator 50, often a thumb turn 51, and/or a second outside actuator 60, which may be a key turn or an electronic keypad 61. Actuators are not limited to those illustrated.

Almost the sole focus of prior art was to provide a quick exit to people in a panic by allowing them, from inside their room, to move a lower handle in either direction in order to simultaneously retract both latches on their door. Moving a lower lever up or down would retract both the lower latch and the deadbolt.

A purpose of the improvements embodied in the present invention(s) is to improve the convenience, efficiency, safety, and other functionality of the double latch lockset 10. The present invention not only allows easy unlocking and exit, but also provides easier locking. At the same time, safer locking is achieved by ensuring the closed position of the latchbolt 310 and deadbolt 510 within a door jamb 3.

In general practice, a user may move a first inside and/or outside actuator 30, 40 in a first direction in order to simultaneously retract the latchbolt 310 and deadbolt 510. (For example, moving a lever 30, 40 down retracts both.) Or a user may move a first inside and/or outside actuator 30, 40 in a second direction in order to project or lock the deadbolt 510. For reasons of safety and functionality, the latchbolt 310, after being spring-loaded into a projected position into the door jamb 3 as soon as the door was closed, remains projected during movement of the first inside and/or outside actuators in the second direction. (For example, moving the lever 30, 40 up projects the deadbolt 510 while the latchbolt 310 remains projected. The steadfastness of the latchbolt 310 assures that during locking a warped door or molding does not push the door 1 open.) Thus, actuation of the first inside and/or outside actuator 30, 40 in a first direction produces an action on both the latchbolt 310 and the deadbolt 510; however, actuation of the first inside and/or outside actuator 30, 40 in the opposite direction produces only a single action on the latchbolt 510.

Although the latchbolt 310 and the deadbolt 510 are connected, actuation of the deadbolt 510, whether from inside or outside, does not open the latchbolt 310. (For example, an interior thumb turn 51, exterior key turn, or keypad 61 may be actuated to unlock a deadbolt 510, but the lower retractable latch 310 remains projected into the door jamb 3.) Thus, the second inside and outside actuators 50, 60 retract only the deadbolt 510.

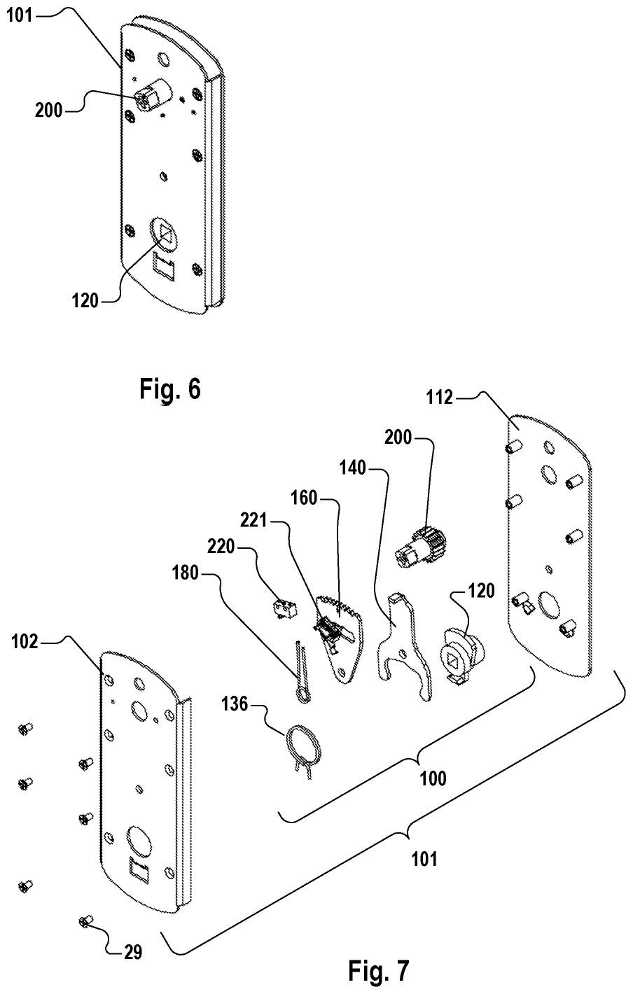

Turning to the specifics of the drive assembly 100, FIGS. 6-15 discuss a basic preferred embodiment and its variations. A housing or cartridge 101 comprises a front plate 102 and a back plate 112, as well as screws 29 or another form of attachment to hold the plates 102 and 112 together. The cartridge 101 also houses a drive cam 120, a second latch (deadbolt) trigger 200, and a transmission that asymmetrically couples the drive cam 120 to the deadbolt trigger 200. The transmission comprises a first reactor plate 140 and a second reactor plate 160 that are configured to transmit motion of the drive cam to the deadbolt trigger 200 to cause the latchbolt 310 and the deadbolt 510 to retract at about the same time (i.e., in tandem), while preventing a transmission of sufficient motion of the deadbolt trigger 200 to the drive cam 120 to retract the latchbolt.

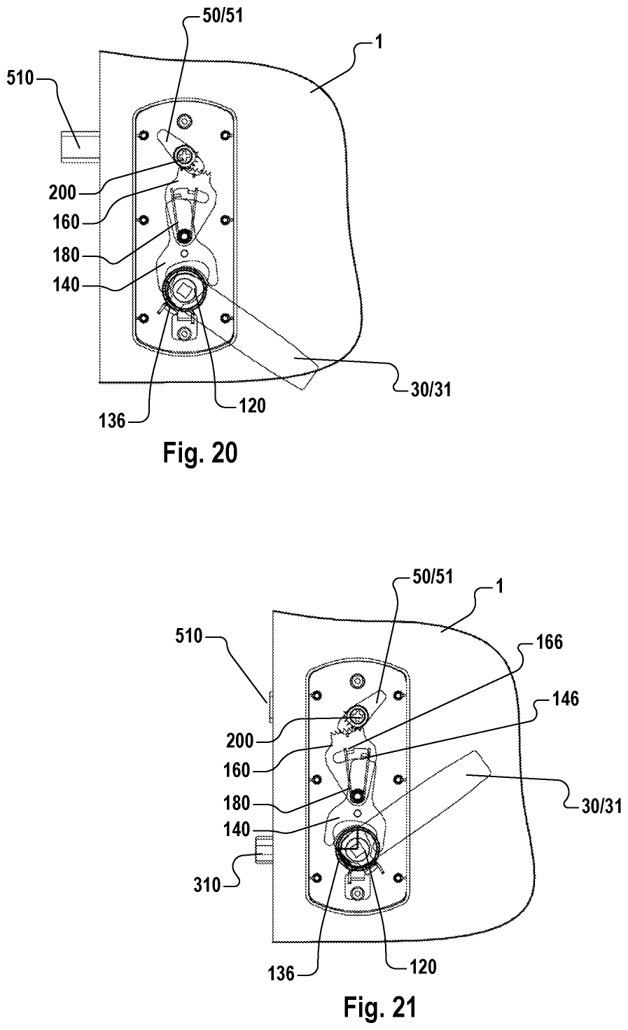

The drive cam 120 has an aperture 129 configured to be acted upon by the tailpiece 42 of the first inside and/or outside actuators 30 and 40. The drive cam 120 comprises a flange 124 that is configured to fit partially within opposing arms 142 of a first reactor plate 140 and to rotate, its cam tab 126 subject to restriction by a torsion spring 136 configured to cooperate with a spring stop 106 on the front plate 102, and act upon an inner surface 143 of either of the two opposing arms 142. The first reactor plate 140 is configured to act in turn upon a second reactor plate 160 via a first pivot point 168 (proximate the overlap of the first and second reactor plate bodies 140, 160) and a second pivot point at a pivot tab 146, the latter of which passes through an arcuate opening 164 in the second reactor plate 160 near a reactor tab 166 on the second reactor plate 160, both the pivot tab 146 and reactor tab 166 engaging an escapement spring 180 designed to resist over-rotation of the second reactor plate 160, thus making a deadbolt 510 harder to break (see FIGS. 20-21). The first pivot point 168 and the pivot tab 146 together may be referred to as “two pivot points,” the term “point” referring to a proximate area rather than a discrete point.

Characterized in another way, the drive cam 120 is configured when rotating in a clockwise direction to drive the first reactor plate 140 to rotate in a counterclockwise direction about a pivot point 168, and when rotating in a counterclockwise direction to drive the first reactor plate 140 to rotate in a clockwise direction. A coupling between the first and second reactor plates 140 and 160 configures the first and second reactor plates 140, 160 to move substantially in unison to operate the deadbolt 510 unless movement of either the first or second reactor plates 140, 160 is blocked relative to the other.

The drive assembly 100 includes a lost motion mechanism that leaves the latchbolt 310 in its pre-existing position (e.g., projected) after a door handle is released from a deadbolt-projecting position to return, under the force of its return torsion spring, to a neutral, default position. The drive assembly 100 only begins to retract the latchbolt 310 after the door handle is turned, against the resistive force of the torsion spring, to a latch-retracting position. This lost motion mechanism also holds the deadbolt 510—after it returns to the neutral, default position from a deadbolt-retracting position (caused by, e.g., pushing the lever downward) against the force of the torsion spring, in its retracted position—and only begins to project the deadbolt 510 after the handle is pulled, against the resistance of the torsion spring, to a deadbolt-projecting position (e.g., by pulling the lever upward).

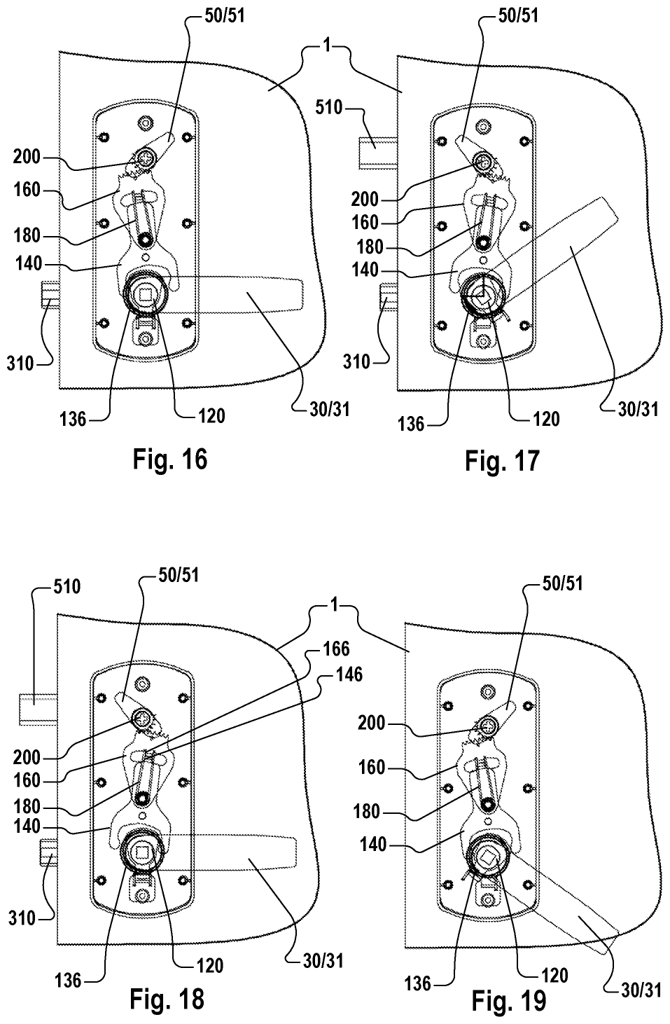

It should be appreciated, however, that the exact location of the lost motion is not critical. In FIGS. 16-21, for example, lost motion is concentrated in the loose link between the drive cam 120 and the legs of the first reactor plate 140. But lost motion could be distributed through many interconnections in the drive assembly 100, or concentrated between other interconnections in the drive assembly. These include the pivot-and-spring 180 interconnection between the first and second reactor plates 140 and 160, a lost motion mechanism incorporated into the interconnection of the second reactor plate 160 and the deadbolt trigger 200. Alternatively, lost motion can be incorporated into other links between and including the latchbolt mechanism 310 and the deadbolt mechanism 510.

The second reactor plate 160 is configured in turn to act upon a deadbolt trigger 200 that is configured to retract or project the deadbolt 510. The second reactor plate 160 may be referred to as a follower plate or multiplier and may comprise a rack 162 configured to coact with a deadbolt trigger 200 that comprises a gear having teeth 202. However, the second reactor plate 160 may not be a rack 162 and may still be configured to coact with a deadbolt trigger 200 that comprises an arm, and said arm may be rotatable.

Sensors 220, 221 may be included to detect the position of the second reactor plate 160, thereby deducing the position of the deadbolt 510 with respect to the deadbolt assembly 500. Electronics and sensors in general may be complex or simple, and they may pertain to one or both of the latchbolt 310 and the deadbolt 510 and to the drive assembly 100. However, the double latch lockset 10 may also be fully mechanical with no electronics or sensors.

FIG. 9 provides a nice view of the relationship among the parts of a drive assembly 100. As stated previously, the deadbolt trigger 200 does not act in reverse order upon the drive cam 120, as the torsion spring 136 returns the drive cam 120 to its neutral position and the first reactor plate's 140 arms 142 are configured to avoid such reverse action. Alternatively, FIGS. 22-24 show three varied configurations that allow similar relationships among the parts of a drive assembly 100. In each, a drive cam 120 acts upon a first reactor plate 140, which acts upon a second reactor plate 160 (which may or may not cooperate with an escapement spring), which acts upon a deadbolt trigger 200 that comprises an arm.

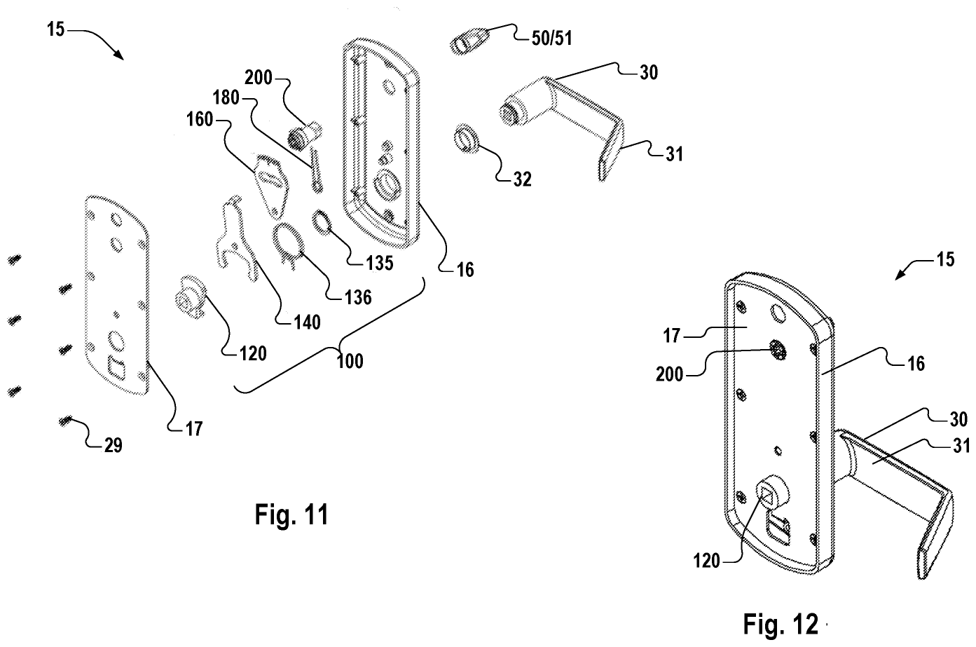

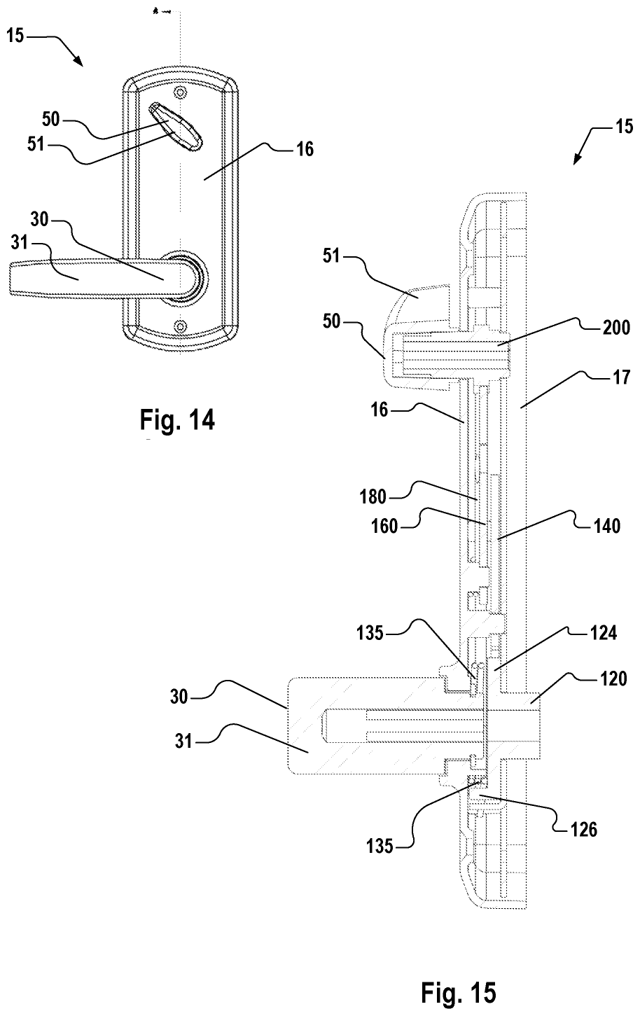

FIGS. 11-15 illustrate a variation on the drive assembly 100. The main difference is that the parts are mounted on the inner cover 16 or back plate 17 of the inner trim 15 without use of a separate cartridge 101 housing. In any configuration, retaining rings 135 and bushings 32 may be used as needed to secure parts. FIG. 15 shows how parts of a drive assembly 100 may be fitted together or stacked one upon another in a relatively narrow space. Achieving the described functionality and structure in a limited, slim space is of significant value to the invention, as the resultant product must meet user expectations in the market. Those expectations include an attractive finish, for example as seen in FIG. 14, and an ability to install the lockset 10 in standard doors that already have latch holes.

Shown in cross-section in FIG. 15, the inner trim 15 comprises inner cover 16 and back plate 17 sandwiching the parts. At the lower, first inside actuator 30, the torsion spring 136 holds the drive cam 120 in place and in alignment with the first reactor plate 140, which stacks against the second reactor plate 160 and cooperates with escapement spring 180. The second reactor plate 160 is aligned with the deadbolt trigger 200 of the upper, second inside actuator 50.

Returning now to the drive assembly 100 parts as arranged in FIG. 9, FIGS. 16-21 illustrate movement of the parts of the lockset 10 as the first inside and/or outside actuator 30, 31 is moved. For ease of discussion, the first actuator 30, 31 moving in a first or second direction is shown by a lever 30/31 moving down or up. (Of course, the first and second direction may alternatively be described as moving up or down.) FIG. 16 shows the door 1 in a normal unlocked position with deadbolt 510 retracted and latchbolt 310 projected. FIG. 17 shows the lever 30/31 moved up, causing the drive cam 120 to act on an arm 142 of the first reactor plate 140, which acts through the second reactor plate 160 to turn the deadbolt trigger 200, thus also turning the thumb turn 50/51 (second inside actuator) and projecting the deadbolt 510. Very importantly, the first latch bolt 310 does not retract during this movement, thus keeping the door 1 closed and keeping the deadbolt 510 aligned with its related jamb recess 4.

FIG. 18 shows the door 1 in a normal locked position with both the latchbolt 310 and deadbolt 510 extended. The only difference from FIG. 17 is that the torsion spring 136 returned the lever 31 to its normal state. (Note that if the deadbolt thumb turn 50/51 in FIG. 18 is turned to unlock the deadbolt 510, the arm 142 shown on the left side of the first reactor plate 140 will return to the position shown in FIG. 16, and it does not act on the flange 124 of the drive cam 120 or affect the latchbolt 310.) FIG. 19 shows the lever 30/31 pulled down and retracting both the first and second latches 310, 510. The lever 31 causes the drive cam 120 to act on the opposite arm of the first reactor plate 140, thus acting through the second reactor plate 160 to turn the deadbolt trigger 200, rotate the thumb turn 50/51, and retract the deadbolt 510.

FIGS. 16-19 demonstrate that after the drive cam 120 acts upon the first reactor plate 140 to either project or retract the deadbolt 510, the torsion spring 136 drives the cam 120 back to its default, neutral position. Meanwhile, the first reactor plate 140 comes to rest tilted in the opposite orientation that it has prior to the action. This is illustrated by the contrasting orientations of the first reactor plate in FIGS. 16 and 18. This toggling action positions the arm 142 that had been acted upon away from the drive cam flange 124, and the opposite arm 142 near to the drive cam flange 124. This not only enables the drive cam flange 124 to drive the reactor plate 140 in the opposite direction, but also prevents direct action on the thumb turn 50/51 from acting on the drive cam 120 in reverse.

For example, FIG. 19 illustrates retraction of both latch bolts 310, 510 as the drive cam 120 rotates clockwise to push the arm 142 on the right side, and then the drive cam 120 with latch bolt 310 and the lever 31 return counterclockwise to rest (aided by both the torsion spring 136 and the spring mechanism of the latchbolt 310 itself) as seen in FIG. 16, with the arm 142 on the left side positioned to be acted upon by the drive cam 120 for locking initiated by the drive cam 120. The right-side arm 142 is now out of range of the drive cam flange 124 such that the right arm 142 cannot act upon the drive cam 120 if the deadbolt 200 is projected via the thumb turn 51. FIGS. 22-24 show alternate, but similar, shapes for the drive cam 120 and first reactor plate 140, but in each case the drive cam 120 cannot be driven by the first reactor plate 140.

FIGS. 20 and 21 illustrate the protection afforded to the deadbolt 510 and the drive assembly 100 by an escapement spring 180. In FIG. 20, if the deadbolt 510 is blocked during retraction/unlocking, a common response might be to turn push the lever 31 down harder and farther (or to act similarly on an upper actuator 50, 60). The escapement spring flexes and widens, allowing the first reactor plate 140 with pivot tab 146 to move relative to the second reactor plate 160 and its reactor tab 166 without breaking the latchbolt 310 or the deadbolt 510. In FIG. 21, if the deadbolt 510 is blocked during projection/locking, a common response might be to push the lever 31 harder and farther up or to turn the thumb turn 51 harder and farther. The escapement spring flexes and widens, allowing the second reactor plate 160 with reactor tab 166 to move relative to the first reactor plate 140 and its pivot tab 146. In this way, the thumb turn 51 and its associated second inside actuator 50 has room to give without breaking the second inside actuator 50.

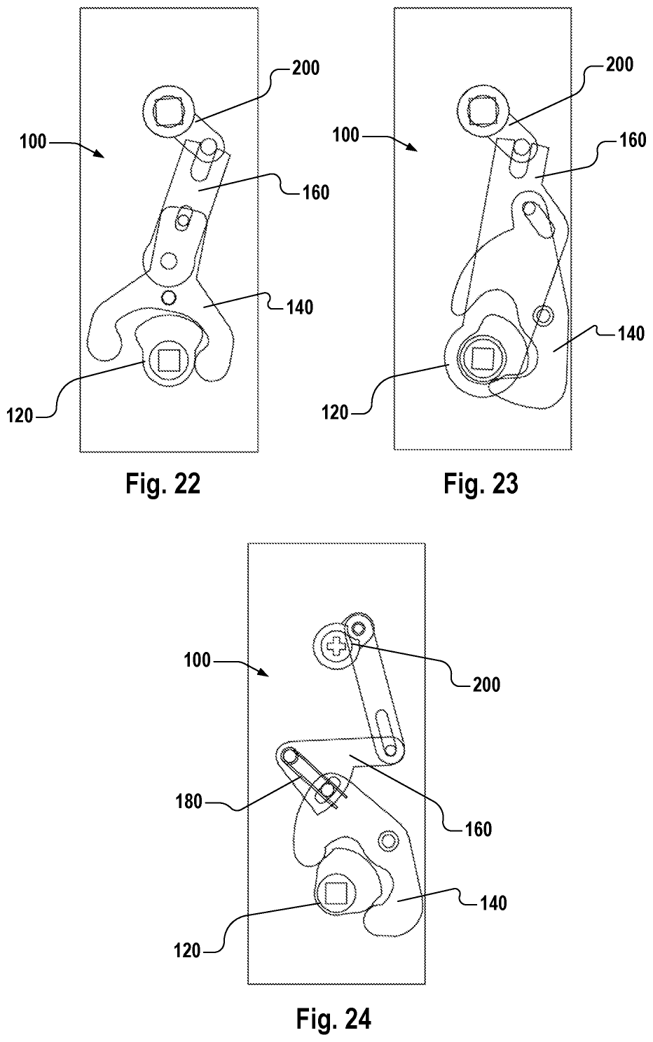

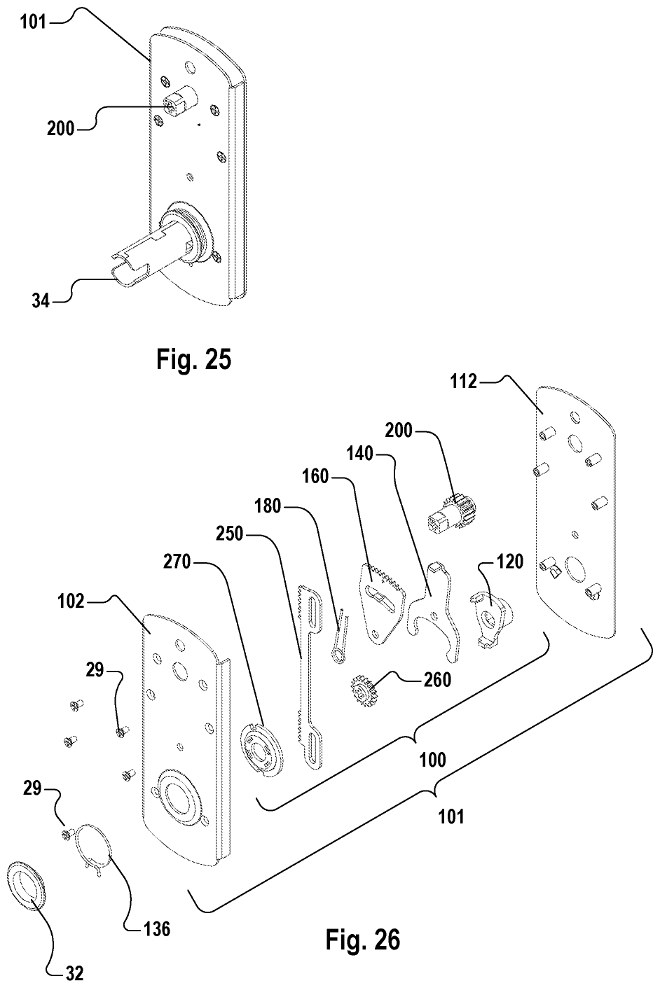

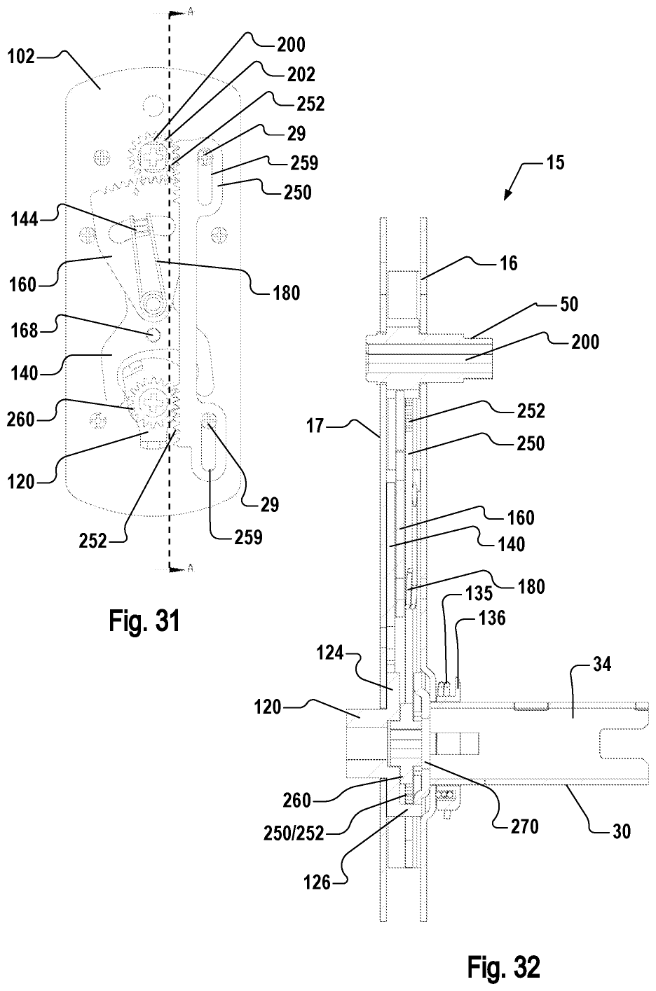

An enhanced embodiment of a drive assembly 100 is found in FIGS. 25-32. In particular, FIG. 31 illustrates the interaction of the parts and is useful for comparison to the drive assembly of FIG. 9. In an electronic version, the outer lever 41 may be non-operable (either locked, clutched, or disconnected) when the deadbolt 510 is locked and operable when the deadbolt 510 is retracted. The cartridge 101 is altered to house a locking rack 250 configured to enable a second actuator 50, 60 to lock a first outside actuator 40 (for example, the action of “throwing” or locking the deadbolt 510 also locks the latchbolt 310). As shown, slots 259 on the locking rack 250 permit the locking rack 250 to travel up and down in linear motion while secured by two screws 29 that join the front cartridge plate 102 to the back plate 112. However, the locking rack 250 may be otherwise movably secured and may be arched rather than linear. Opposing each slot 259 may be teeth 252 configured to coact with gears. One gear may be a pinion 260 associated with the drive cam 120, and another gear may be a deadbolt trigger 200 with teeth 202 (an alternate version is configured for a deadbolt trigger 200 that is a rotatable arm). A spindle washer 270 holds the pinion 260 in cooperation with the drive cam 120, and the drive cam 120 is activated via a spindle sheath 34 through the spindle washer 270. In this instance a torsion spring 136 and bushing 32 are located outside of the cartridge 101 proper, though other internally located configurations are possible. Thus, the locking rack 250 is an additional connection between the first and second actuators 30, 40 and 50, 60 that is designed to bind the first outside actuator 40 for additional security when the deadbolt 510 is locked. In practice, moving a first inside and/or outside actuator in a second direction (i.e., lever up) causes the deadbolt 510 to project and also trips the locking rack 250 to lock the lower trim/outside actuator 40. Projecting the deadbolt 510 using the second inside or outside actuator 50, 60 has the same effect. With modification, similar functionality may be achieved for use with a keyed, mechanical deadbolt 510.

In cross-section, FIG. 32 shows the inner trim 15 comprising front cover 16 and back plate 17 sandwiching various parts of the drive assembly 100. Pinion 260 is positioned between the drive cam 120 and spindle washer 270 such that the spindle sheath 34 of the first inside actuator 30 may act on the spindle washer 270, which cooperates with the drive cam 120. The pinion 260 is aligned with the locking rack 250 and positioned to coact with a lower set of teeth 252. At the other end of the locking rack 250, the deadbolt trigger 200 is positioned to coact with an upper set of teeth 252. Other parts are “stacked” as described previously, with the torsion spring 136 now located with the spindle sheath 34. As noted earlier, inventing in the confines of this small space often speaks to non-obviousness regarding structure, functionality, and efficiency of parts and motion. One of skill in the art will recognize that prior art, whether alone or in combination, does not achieve the same functionality or efficiency.

Description of Embodiments Derived from Ser. No. 17/093,534: Improved Double-Latch Lockset with Deadbolt-Locking Outside Handle

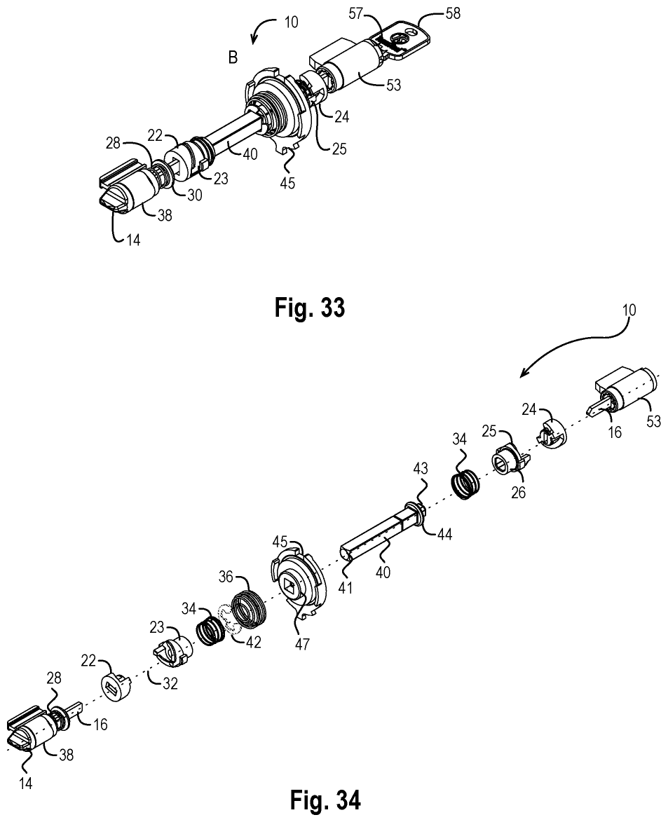

FIGS. 33-35 illustrate assembled and exploded views of one embodiment of a lock stem and main spindle assembly 410. The spindle assembly 410 comprises two key cylinders 453 for keyed operation or, in what is expected to be more typical, a key cylinder 453 for the outside and a manually operated lock button cylinder 438 for the inside. Other variations are also contemplated.

The lock button cylinder 438 is, in one implementation, operated with an ingress-controlling lock button 414. The lock button 414—which is mounted to the button cylinder 438—may be a push button, a twist button, or a combination of the two that locks or unlocks the latch to ingress. In the implementation of FIG. 434, a twist lock button 414—which is biased into a selected detent position by coil spring 428 which is seated against a washer 430—is utilized. It will be understood that the lock button cylinder 438 could be replaced with any other suitable locking mechanism compatible with a sliding spindle mechanism as claimed herein.

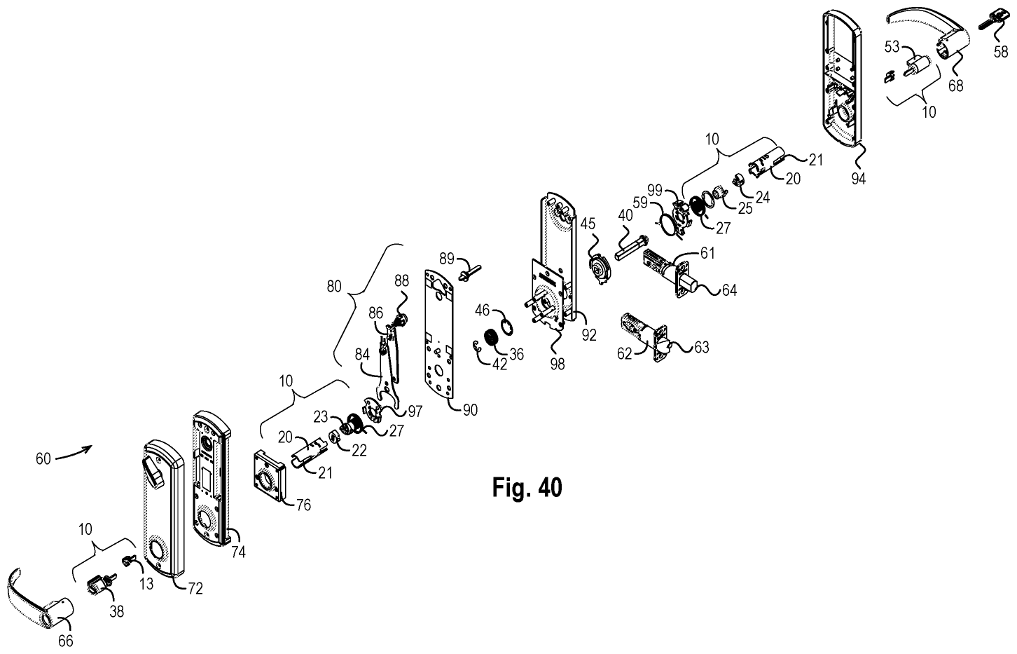

The inside handle 466 (FIG. 40) is mounted on the inside handle cylinder 420. The outside handle 468 is mounted on the outside handle cylinder 420. Each of the key cylinder(s) 453 and/or lock button cylinder 438 carry a key cylinder stem 416 or a lock button cylinder stem 416. The stems 416 turn with the button 414 or key 458 to which it is connected. This enables rotational motion from the button 414 or the key 458 to be transmitted to a sliding spindle mechanism of the lock stem and main spindle assembly 410.

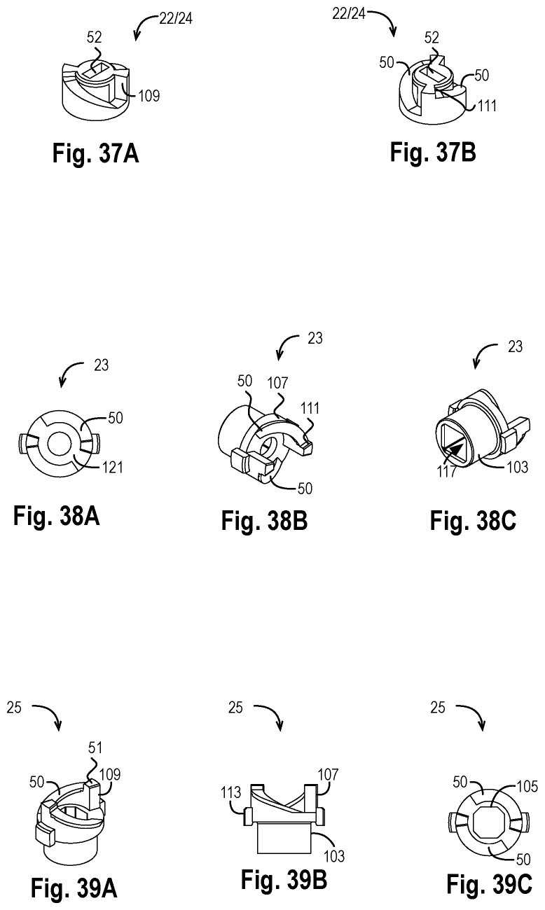

The sliding spindle mechanism comprises two collapsible and expandable barrel assemblies and the main spindle 440. Each barrel assembly comprises a barrel cam 422 or 424 (which in one implementation are identical) cooperating with a barrel cam follower 423 and 425 (which in one implementation are mostly identical). Slots 452 (FIG. 37A) in the button-side barrel cam 422 and a key-side barrel cam 424 receive stems 416 and/or 414 of the key and/or button cylinders 453 and/or 438. Also, each barrel cam follower 423, 425 has an axially-oriented hole—a blind square hole 517 for the barrel cam follower 423 and a non-equilateral octagonal through hole 505 for the barrel cam follower 425—that fits snuggly but non-interferingly over the ends 441 and 443, respectively, of main spindle 440.

Accordingly, actuation of a thumbturn button 414 or key 458 causes rotation of the barrel cam 422 or 424 of the sliding spindle mechanism. This, in turn, drives the barrel cam follower 423 or 425, respectively, to either slide the main spindle 440 axially in and out of engagement with the key-cylinder side barrel cam follower 425, or axially slide the barrel cam follower 425 into engagement with the main spindle 440.

FIGS. 37-39 illustrate embodiments of barrel cams 422 and 424 and their corresponding barrel cam followers 423 and 425. In FIG. 37, identical barrel cams 422 and 424 are positioned on opposite thumbturn and key-cylinder sides of the spindle assembly 410. FIG. 38 shows a button-side spindle driving barrel cam follower 423 against which barrel cam 422 acts. FIG. 39 illustrates a key-cylinder-side spindle driving barrel cam follower 425 against which barrel cam 424 acts.

The “cam” of each barrel cam 422 and 424 consists primarily of two symmetrically opposed helix-contoured ramps 450 that helix about 120° around opposite perimeter sections of the barrel cam. The top of each ramp 450 begins at a stop 511 and ends just before a shoulder 509. In the implementation shown, the ramps of the barrel cams and barrel followers 422-425 descend in a counterclockwise direction, when facing the ramps 50. Accordingly, in this implementation, as a barrel cam 422, 424 twists in that direction, which is also the clockwise direction when facing the bottom of the barrel cam 422, 424, the barrel cam 422, 424 urges the corresponding barrel cam follower 423, 425 to move to a distal, less juxtaposed position, away from the barrel cam 422, 424, and closer to the center of the door borehole. The present disclosure is, of course, easily adapted to mechanisms that reverse the rotational directions discussed above.

In the barrel cam followers 423 and 425, the ramps 450 are located along the upper portion 507 of the barrel cam followers 423 and 425. Each of the barrel cam followers 423 also have helix ramps 450 similar to and shaped to cooperate with those of the barrel cams 422 and 424. Shoulders 109 block the barrel cams 422-425 from rotating with respect to each other past a fully juxtaposed limit. The top of the shoulder 109 acts as a stop 451 that prevents the barrel cams 422-425 from rotating with respect to each other past a most distal, nearly separated limit. Side tabs 513 seat the barrel cam followers 423 425 into the slots 421 of the handle spindles 420 (FIG. 40). The illustrated handle spindles are formed of rolled-up stamped sheet metal, but in another embodiment the handle spindles are formed by machining.

Each of the barrel cams 422, 424 and barrel cam followers 423, 425 have a cylindrical body and a circular base, upper 507 and lower 503 sections, and shoulders 509 and tabs 507. The cylindrical or barrel shape conforms with the tubular handle spindles 420 in which they are seated. The base portion 503 is smaller in diameter than the upper portion 507, and the interface between these two portions 503 and 507 provide a spring seat for a spring 434.

The square holes incorporated in the barrel cam followers 423 and 425 interface the followers to the main spindle 440. The blind square hole 517 of follower 423 selectively receives and clutches a thumbside end 441 of the square spindle 440, until it butts up against a blind hole bottom 506 that acts as a stop to the spindle 440. The key-side through hole 505 of follower 425 selectively receives and clutches a key-side end 443 of the spindle 440. The non-square shape (e.g., octagonal) of the through hole 505 frustrates over-torqueing attacks by making it more difficult to use a screwdriver or other tool to operate the lockset 460 if the cylindrical lock is removed in an attack.

Each of the barrel cam followers 423 and 425 are biased away from an outside-handle-enabling positions (i.e., positions engaging the barrel cam follower 425 to the main spindle 440) by a spring 434 and into close juxtaposition with its respective barrel cam 422 or 424. The springs 434 are staked against stop plates 29 in the inside and outside lock trims. The main spindle 440 is operable to move along axis 432 between a clutching position that engages the outside handle 468 and one that frees the spindle 440 from the “clutch” or grasp of the outside barrel cam follower 425 along with the handle 468 to which it is connected. Depending on whether the spindle 440 is clutched, rotation of the outside handle 468 rotates the spindle 440 about its axis 432, which in turn drives the latch link assembly 462 (FIG. 40) to project or retract the latchbolt 463. In summary, each barrel cam and follower pair (422 & 423, 424 & 425) comprises a selectively collapsible and expandable assembly that lengthens and shortens to axially reposition the main spindle 440 in response to button 414 actions or key 458 turns.

A spring 436 is mounted about the spindle 440 between a secondary spindle driver 445 and a retaining clip or clip plate 442 mounted on the spindle 440. The spring 436 urges the square spindle 440 toward the “inside” facing part of the door and lock hardware.

Turning the stem 416 and/or 414 cams the latch-operating square main spindle 440—which operates a latch-retracting assembly 462—between clutch-engaging and clutch-disengaging positions along the axis 432 of the main spindle 440. More particularly, turning the twist lock button 414 from a first position to a second position engages the outside handle 468 to the spindle 440, unlocking the lock mechanism and allowing ingress from the outside to the inside. Turning the button 414 back from the second position to the first position disengages the outside handle 468 from the spindle 440, locking the lock mechanism and hindering ingress from the outside to the inside. This disengages the outside handle 468 from the spindle 440, preventing ingress from the outside to the inside.

In another embodiment, not shown, the button cylinder 438 with its combination button 414, and the barrel cam and follower 422 & 423 are replaced with a push button connected to a clutch sleeve. No rotation of the push button is involved. Because it is a push button, the clutch sleeve is caused to advance linearly without any camming action. Alternatively, two-barrel cam and follower pairs (or a 3-part equivalent)—with one of the followers constituting a clutch sleeve—are used, back-to-back, on the button side of the lockset 460 to amplify or reduce the ratio of button axial movement to clutch sleeve axial movement. To amplify or reduce the ratio, the ramp slopes for the two back-to-back barrel cams are different.

It should be observed that barrel cam follower 425 may alternatively be characterized as a clutch sleeve. In the depicted embodiment, the barrel cam follower 423 does not function as a clutch sleeve because it is spring-biased to always engage the button-side end 441 of the spindle 440. In other embodiments, the barrel cam follower 423, or both barrel cam followers 423 and 425 could disengage from the spindle 440, thereby functioning as a clutch sleeve or sleeves. But this would change the function of the inside handle 466, configuring it to turn freely without engaging the spindle 440 when the button 414 is projected. Generally, this is not desired, although there may be some useful applications (e.g., emergency lockdown), perhaps including additional modifications (e.g., electronic triggering abilities to put the doorknob in a projected position).

Advantageously, the sliding spindle mechanism described above makes it possible to enable two mechanisms—the button 414 and the key 458—to engage or disengage the same keyside-proximate barrel cam follower 423 to the keyside end 443 of the spindle 440. This way, the spindle 440 is engaged whenever the key 458 or the button 414 is actuated. Only when both the key 458 and button 414 are in locked positions does the spindle 440 stay disengaged from the outside handle 468. When the inside button 414 is disengaged, the outside handle is normally unable to retract the latch. Instead, it can be moved freely but nonoperatively through its range of motion. However, operating a key 458 in the keyed actuator of the outside door handle causes barrel cam 424 with a partially spiraling ramp portion to urge barrel cam follower 425 into a clutching configuration with respect to the second end 443 of the square spindle, thereby configuring the outside handle 468 to be operated to retract the latchbolt 463.

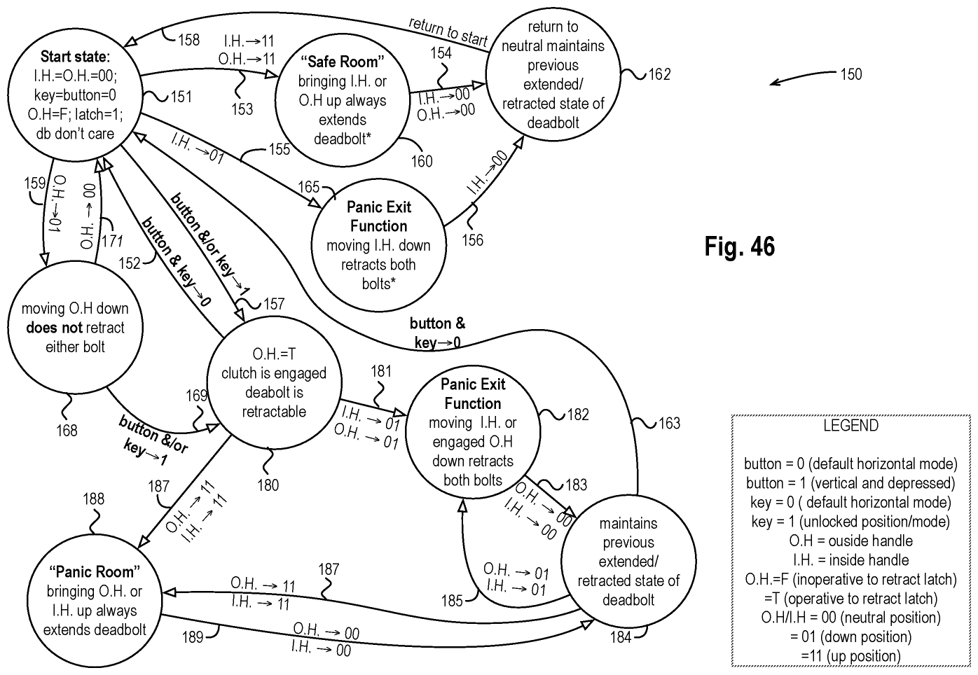

FIG. 46 illustrates an alternative main spindle 471 and key-cylinder side barrel cam follower 475 in which the male insert 477 and female receiver 473 are swapped so that they belong to the barrel cam follower 475 and main spindle 471, respectively. This may have an advantage over the earlier disclosed embodiment with respect to resisting an attack using a screwdriver or other implement. Otherwise, the functions are identical. In yet another embodiment, not shown, a similar swap is done on the thumbturn side, so that the thumbturn-side end of the main spindle 440 or 471 incorporates a receiver, and the receiver 503 of the thumbturn-side barrel cam follower 423 is replaced with a male insert 477.

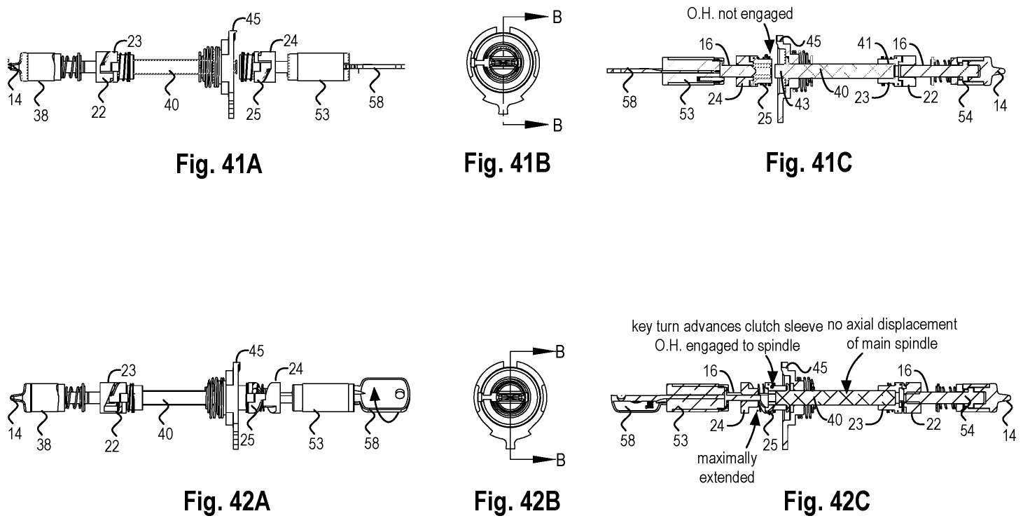

FIGS. 41-43 illustrate the relation of the barrel cam followers 423 and 425 to their respective barrel cams 424 and 425 when the lockset 460 is locked (unclutched) to the outside, unlocked by the key 458, and unlocked by the thumbturn, respectively. In FIG. 41A, the depressible thumbturn 414 is in a locking position and the key 458 has just been inserted but not yet turned. In FIG. 41C (which is a cross-section of FIG. 41B along C-C, which is a cross-section of FIG. 41A along B-B), there is no engagement of the barrel cam follower 425 (and outer handle 468) with the key-side end 441 of the spindle 440. Both the outer barrel cam 424 and barrel cam follower 425 are maximally juxtaposed together, meaning that they are minimally extended. The same is true for the inner barrel cam 422 and barrel cam follower 423. In other words, both the barrel cam followers 423 and 425 are maximally retracted from the spindle 440. Therefore, the outer handle 468 is unclutched so that the door is locked. Stated another way, the outer handle 468 is interoperatively disengaged from the latchbolt 463.

In FIG. 42A, the key 458—and with it the barrel cam 424—is turned clockwise (in this implementation), pushing the barrel cam follower 425 into a maximally extended, minimally juxtaposed position with respect to the barrel cam 424. In FIG. 42C, the key-side end 443 of the spindle 440 is therefore received into the blind hole 505 of the barrel cam follower 425. This clutch action enables the outer handle 468 to operate spindle 440 and in turn retract the latchbolt 463. In this action, it is not necessary to move the spindle 440 along its axis 432. This mechanism may simply move the barrel cam follower 425 over the spindle 440.

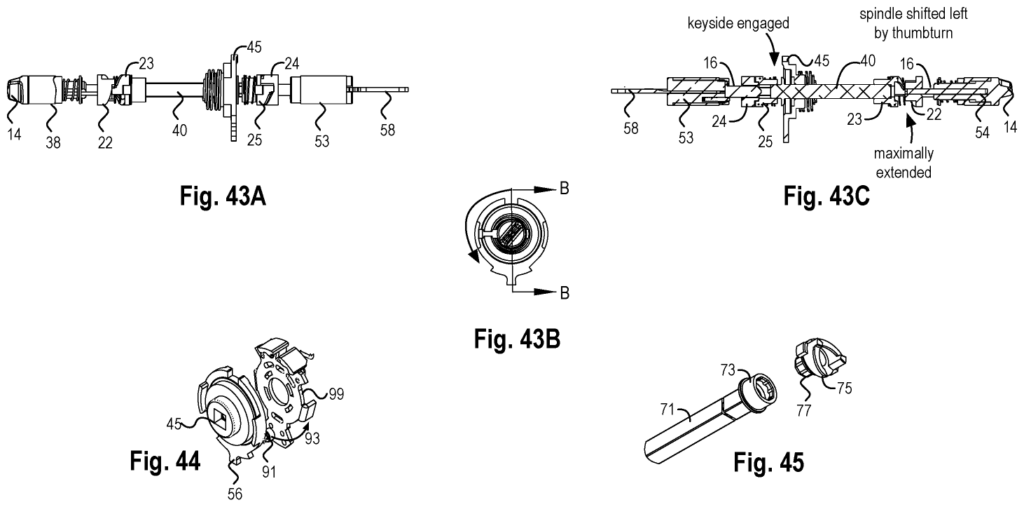

In FIG. 43A, the key 458 is left in its inactive FIG. 41 position and instead the thumbturn 414 is pressed inward, against spring pressure, and turned clockwise. In FIG. 41, the button-side end 441 of the spindle 440 was already fully received into the blind hole 517 of barrel cam follower 423 (as it should always be). Therefore, in FIG. 43, the turning of the thumbturn 414 pushes not only the barrel cam follower 423, but also the spindle 440 itself, toward the key 458 side of the door. This, in turn, pushes the key-side end 443 of the spindle 440 into the blind hole 505 of the key-side barrel cam follower 425 and into clutching engagement with the key-side barrel cam follower 425. In this action, there need not be any linear axial movement of the key-side barrel cam follower 425. Thus, the key-side barrel cam 425 may remain stationary, for the linear axial movement of the spindle 440 is sufficient to “clutch” the outside door handle 468 to the spindle 440.

The foregoing description has focused on FIGS. 43, 44, 37-39 and 41-43 while referring sparingly to some elements of FIG. 40. FIG. 40 is an exploded view of one embodiment a dual latch and deadbolt assembly as described in U.S. patent application Ser. No. 15/393,679 that incorporates a lock stem and main spindle assembly 410 as described above and in U.S. patent application Ser. No. 17/093,534. In locksets with a deadbolt (such as that shown), the dual latch and deadbolt assembly comprises a cam driver 497 that interacts through a lost motion mechanism with a deadbolt link assembly 480. The deadbolt link assembly 480 comprises a cam driver 497 that transfers motion to a first reactor plate 484, which transfers motion to a second reactor plate 486, which transfers motion to a deadbolt trigger gear 488, which transfers motion to a deadbolt tailpiece 489, which transfers motion to a deadbolt assembly 461. As described in connection with the '679 application, the deadbolt link assembly 480 harnesses upward motion of lever 466 to project the deadbolt 464.

FIG. 40 also reveals another significant secondary aspect that enhances the functionality of the lockset 460. The lockset 460 reveals two mechanisms for operating the main spindle 440 from the outside handle 468—(1) the key-and-thumbturn-enabled mechanism that has been the focus up to this point and (2) an independent deadbolt-locking mechanism that operates through a secondary spindle driver 445.

The key-and-thumbturn-enabled mechanism selectively enables the outside lever 468 to be turned downwardly (or its rotational equivalent) to retract the latchbolt 463 and, if the deadbolt is projected, the deadbolt 464. The secondary spindle driver 445, by contrast, enables the outside handle 468 to be turned upwardly (or its rotational equivalent) to lock the deadbolt. This secondary action transmits motion from the outside handle 468 to the handle coupler 499 to which the outside handle 468 is staked, down to a pin 491 (such as a socket head cap screw) riding on a handle coupler paddle. The motion is conveyed from the pin 491 to a tab 456 of the secondary spindle driver 445, thereby driving the spindle 440 to rotate in the same direction as the outside handle 468. In one implementation, this lever-lifting movement does not retract the latchbolt 463, because a latch assembly 462 is selected that only allows one (i.e., the lever-depressing) direction of rotation to retract the latchbolt 463.

When the outside handle 468 is turned downwardly, the pin 491 rotates away from—not against—the tab 456. Therefore, the reverse rotation of the handle coupler 499 does not convey motion to the secondary spindle driver 445. The only way for downward movement of the outside handle 468 to gain access through the locked door, gate or other barrier is for the barrel cam follower 425 to be clutchingly engaged to the main spindle 440. When clutchingly engaged (i.e., engaged in the manner in which a clutch engages), downward movement of the outside handle 468 retracts the latchbolt 463 and the deadbolt 464.

Incidentally, the secondary spindle driver 445 is mounted on the main spindle 440 on the left side of the flange 444 of the main spindle 440 (from the perspective of FIG. 34). The flange 44 acts as a limit to the leftward range of the main spindle 440. When the flange 444 nests inside the left side of the secondary spindle driver 445, the secondary spindle driver 445 blocks the main spindle from traveling any further to the left.

The assembly 460 also comprises an inside housing 474 for housing the interconnecting latch and deadbolt assembly of the above application, including a drive cam 497, a first reactor plate 484, a second reactor plate 486, and a deadbolt trigger 488. Moreover, it comprises the elements of the lock stem and main spindle assembly 410 described above with respect to FIGS. 33-35. The dual latch and deadbolt assembly 460 further comprises a latch linkage assembly 462, a deadbolt link assembly 461, and inside and outside handles 466, 468. Of course, for new installations, the assembly 460 includes inside and outside faceplates 472, 494 and inside and outside door plates 490, 492, a housing plate 498 and cooperating holding plate 476 used to assemble together the inside and outside door plates 490, 492. The housing plate 498 and cooperating holding plate 476 provide througholes to hold the spindle 440 from moving off of its axis 432.

Various components, including the latch retracting assembly 462, the secondary spindle driver 445, and the barrel cam follower 425, have low-friction surfaces (e.g., metal, nylon or other plastic) to facilitate sliding, axial movement of the main spindle 440. They also serve to secure the main spindle 440 inside the lockset 460 to its axis 432 for mechanically restrained movement, without radial deviations, along the spindle's axis 432.

There are a few structural and functional details to go over. One is that both the barrel cams 422, 424 and the barrel cam followers 423, 425 sit inside the cylindrical interiors of the handle spindles 420. The inside handle spindle 420 is orbitally staked to plate 497, and the outside handle spindle 420 is orbitally staked to spindle driver 499, retaining the barrel-shaped elements 422-425 inside their respective handle spindles 420.

The barrel cam followers 423, 425 have tabs 113 that slidingly mount into slots 421 of the handle spindle 420. The slots 421 prevent rotation but enable linear movement of the barrel cam followers 423, 425 along a longitudinal axis 432 of the spindle 440. While the non-rotatable barrel cam followers 423, 425 can move axially, the rotatable barrel cams 422 and 424 cannot move linearly along the axis 432.

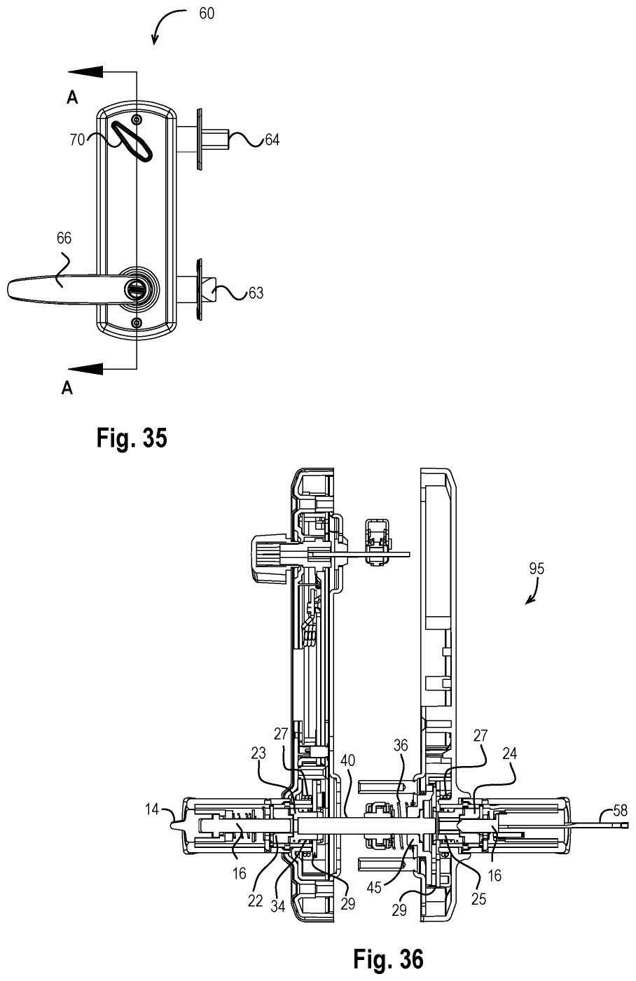

FIG. 35 illustrates an assembled dual latch-and-deadbolt lockset 460, including an inside handle 466, a deadbolt thumbturn 470, latchbolt 463, and latchbolt 464. FIG. 36 illustrates a cross section of the dual latch-and-deadbolt lockset 460 of FIG. 35. In FIG. 36, the barrel cam follower 423 is retracted toward the thumbturn 414 as much as possible, causing the barrel cam follower 423 to be maximally juxtaposed against the barrel cam 422. This means that by turning the thumbturn 414, the barrel cam follower 423 can force the spindle 440 in the key-side direction until the spindle 440 butts up against the blind hole bottom 517. Meanwhile, the barrel cam 424 is minimally juxtaposed against the barrel cam follower 425, forcing the spindle 440 as far as possible in the button-side direction.

Spring 436 is assembled over main spindle 440 between a face of stop plate 498 (FIG. 40) and a snap ring 442, which is fixed over main spindle 440. A cylindrical hub 447 of secondary spindle driver 445 protrudes through a hole of plate 498 and is secured in place by push-on external retaining ring (“push nut”) 446. Spring 436 biases biases the main spindle 440 to the left, from the perspective of FIGS. 34 and 40. In this way, spring 436 “resets” the main spindle 440 out of clutching engagement with barrel cam follower 425.

FIG. 44 illustrates a state machine 550 that at least partially explains functions of one embodiment of the dual latch and deadbolt lockset 460. State machines are typically used to model systems in computer science, logic, and mathematics. They are sometimes useful in modeling machines as well. The lockset 460 described herein can be suitably modeled as a “finite-state machine” in that, for some definition of states, the lockset 460 can be in exactly one of a finite number of states at a given time and changes from one state to another in response to inputs.

The state machine 550 of FIG. 44 is applicable when the lockset 460 is installed on a door or gate or other passageway to enforce restrictions to an access-restricted space or boundary such as a room, building, fenced, partitioned area, or border. Applicant makes no representation that this is the only state machine that can be devised for the lockset 460, or that the state machine 550 is complete. There may be edge cases, corner cases, boundary cases, or special cases that have not been incorporated into the state machine 550.

The default or “start” state 551 of the state machine 550 is arbitrarily characterized by the lockset 460 being locked by at least the latchbolt 463, with neither the button 414 nor the key 458 being activated. The start state could just as easily and arbitrarily be characterized with the button 414 and/or the key 458 being activated.

In state 551, both handles 466 and 468 are in their neutral, spring-biased position (i.e., I.H=00 and O.H.=00). Neither the button 414 nor the key 458 is activated. The latchbolt 463 is projected (i.e., latch=1), which is its default state. For purposes of fitting this state machine 550 onto one page, the start state 551 does not care whether the deadbolt 464 is projected or retracted. Consequently, “O.H=F,” meaning the outside handle 568, when in state 551, is inoperative to open the door.

It would be entirely possible to define the “start” case differently as a state in which the outside handle 468 is unlocked. This would be less convenient, though, because there are three different “locked” states, but only one “unlocked state,” when the states are defined solely by the key and button positions.

Four actions (at least) may be made from the start state 551. In a first action 553, either the inner handle 566 or the outer handle 568 is lifted or turned in a functionally equivalent direction. This action immediately projects the deadbolt 464 (state 560).

This function allows the occupant to immediately and simultaneously secure both the latchbolt 463 and the deadbolt 464. This function—to the extent that it applies to the inside handle 466—may be referred to herein as a “panic room function” in honor of and in allusion to the 2002 thriller film “Panic Room.” This film, starring Jodie Foster, illustrates a break-in and frantic efforts made to secure a safe room from intrusion. The term “room” is used non-literally herein, as the embodiments of this invention are not limited to in-building panic room installations. For purposes of the claims, “panic room” is applicable to any installation in which a lockset such as one descried herein enables deadbolt locking of a lockset from the inside using only the handle.

The inclusion of the handle coupler 499 and secondary spindle driver 445 in the embodiment depicted in FIG. 40 allows deadbolt locking from the outside simply by pulling up the outside handle 468. Advantageously, this enables maintenance personnel managing multiple locks and/or multiple buildings to quickly ensure that all doors are locked, simply by pulling up each outside handle 468.

In action 554, if either handle 466 or 468 is released or gently let down, the handle 466 or 468 returns it to its intermediate, neutral, spring-centered default position (typically horizontal for a lever handle). This puts the lockset 460 into state 562, in which the previous projected or retracted state of the deadbolt 464 is maintained. Coming from state 560, this means that deadbolt 464 remains in a projected position.

In a second action 555 proceeding from the start state 551, the inside/interior handle 466 is pushed down or rotated in a direction equivalent to the handle 466 going down. This action 555 retracts both the latchbolt 463 and the deadbolt 464 (i.e., state 565), immediately allowing egress. The industry refers to this as a “panic function” or “panic lock function” because it allows an occupant to flee with a single lever action.

Typically, state 565 is followed by action 556, in which the door is opened, reclosed, and the inside handle 466 is released, returning the handle 466 to its default position. This puts the lockset 460 into state 562, in which—as stated earlier—the previous projected or retracted state of the deadbolt 464 is maintained. Coming from state 565, this means that the deadbolt 464 remains in its retracted position.

State 562 could be combined with state 551, because the state 551 does not care whether the deadbolt 464 is projected or retracted, the handles 466 and 468 are in the same position, the key 458 and button 414 are in the same position, and the outside handle 468 once again becomes inoperative on return to neutral (O.H.=468) from the panic room and panic function states 560 and 565. Accordingly, path 558 symbolizes the logic returning to the start state 551.

In a third action 557 from the start state 551, the inside button 414 or a key 458 is turned to allow ingress through the passage protected by the lockset 460. This results in the outer handle 468, and in particular the barrel cam follower 425, engaging the spindle 440, either in the manner illustrated by FIG. 42 or the manner illustrated by FIG. 43, and retraction of the deadbolt 464, if it hasn't already been retracted. In the resulting state 580, the outer handle 468 is able to retract the latchbolt 463 (i.e., O.H.=T).

In a fourth action 559 from the start state 551, in which the latchbolt 463 is projected and the outside handle 468 is inoperative to retract the latchbolt 463 (i.e., O.H.=F), the outer handle 468 is pressed down or rotated in an equivalent direction. But as illustrated by state 568, this accomplishes nothing. Because the outside handle 468 is decoupled or disengaged from the spindle 440, neither the latchbolt 463 nor the deadbolt 464 are retracted by this action. Unless the lock button 414 or key 458 is operated, flow returns to the start state 551, as illustrated by path 571.

Whether taking path 569 from state 568 or path 557 from state 551, operation of the lock button 414 and/or key 458 unlocks the lockset 460. In this state 580, the clutch is engaged and the deadbolt is retractable. State machine 550 illustrates three paths proceeding from state 580: lowering either handle (action 581), raising either handle (action 587), or deactivating both the button and the key (action 552). Indeed, state 580 is such a hub that it could serve as a start state in alternative to state 551.

With respect to path 581, lowering the inside handle 466 is always possible, so taking that action retracts both bolts 463 and 464 simultaneously, putting the lockset 460 into state 582. As with state 565, state 582 manifests the panic function with respect to the inside handle 466. In state 580, the clutch formed by barrel cam follower 425 and spindle 440 is engaged, so lowering the outside handle 468 also retracts both bolts 463 and 464 simultaneously, also resulting in state 582. This allows immediate ingress or egress in both directions.

In action 587, raising the inside or outside handle 464 always projects at least the deadbolt 464, if not already projected. It may also be configured to project the latchbolt 463. The resulting state 588 is the same as state 560, except that in state 560, neither the button 414 nor the key 458 are in an active state. In state 588, by contrast, the button 414 and/or key 458 are active.

Path 552 represents deactivating the button 414 and/or key 458. This disengages the clutch, rendering the outside handle 468 inoperative to gain entry. This puts the lockset 460 back into start state 551.

Actions that follow locking or unlocking the lockset 582 may be, and often are, followed by ingress or egress. But that is not necessarily pertinent to the operation of the lockset 460. Therefore, movements of people that do not directly work on the mechanics of the lockset 460 are ignored herein.

The state machine 550 shows one exit path from each of states 582 and 588—letting the handles 466 and 468, with the aid of return springs 427 (FIGS. 36, 40), return to their default position—because it would be unusual to take other paths such as deactivating the key 458 or button 414 before releasing the handles 466 and 468. Releasing the handles 466 and 468 to their default position transitions the state machine 550 from state 582 to state 584.

State 584 maintains the previous projected or retracted state of the deadbolt. State 584 mirrors state 562, except that in state 562, the button 414 and key 458 have not been actuated to engage the outside handle 468 to the spindle 440. In state 584, by contrast, either the button 414 and/or the key 458 have been activated to engage the outside handle 468 to the spindle 440.

State 584 is also presented with three exit actions. In action 585, either of the handles is lowered, landing the lockset 460 into lock state 582. In action 587, either of the handles is raised, projecting the latchbolt 463 and deadbolt 464 to the extent not already projected. In action 563, the button 414 and key 458 are both deactivated, returning the state machine 550 to the start state 551.

The sliding spindle mechanism disclosed herein is advantageously suited to facilities, campuses, and buildings with full-time service or maintenance staff who need to exit locked doors for a brief period of time, for example, to dispose trash, and return quickly. Frequently, doors at large facilities are configured to automatically lock upon exit and require a key or code for re-entry. With a lockset as described herein, maintenance personnel can briefly unlock the door for a “passageway function,” perform their task, and return, locking the lock.

It will be observed that while knobs can certainly be used for the lockset 460 described herein, there is an advantage to using levers. With levers, the directions (up or down) are consistently matched with respective functions (locking or unlocking). With knobs, the direction of rotation of the inside knob is matched to the opposite direction of rotation for an outside knob. For example, if rotating an inside knob clockwise retracts the latch, the outside knob would have to be rotated counterclockwise to retract the latch. This inconsistency could delay an occupant from fleeing a burning building (panic function) or from blocking a pursuer from entering the abode (panic-room function). By contrast, consistent use of the levers—up to lock; down to go through—leads to rapid subconscious memorization of what action is needed to lock and what action is needed to go through.

The dual latchbolt-and-deadbolt lockset disclosed herein may be further characterized in that it comprises a clutch, wherein the passageway function is implemented by engaging the clutch and the lock function is implemented by disengaging the clutch, so that the outside door handle is still free to rotate along its path of rotation but is unable to turn the spindle to retract the latch. The dual latch-and-deadbolt lockset may also be further characterized in that it comprises an outdoor deadbolt locking function wherein movement of a connected outside door handle in the first direction projects the deadbolt and an outdoor pass-through function wherein when a key is used to unlock a key cylinder in the outside door handle, movement of the connected outside door handle in the second position retracts both the deadbolt and a latchbolt.

Accordingly, the foregoing disclosure may be characterized as a method of controlling access between two spaces separated by a door, the method comprising equipping the door with a lock comprising the following functions: (1) an indoor deadbolt locking function wherein movement of a connected inside door handle in a first direction from a neutral main position to a first extent projects a deadbolt; (2) an indoor panic-exit function wherein movement of the connected inside door handle in a second direction opposite the first direction from the neutral main position to a second extent retracts both the deadbolt and a latchbolt; and (3) an inside door handle button whose positions select between a passageway function in which the outside door handle is operable to retract the latchbolt and a lock function in which the outside door handle is inoperable to retract the latch; wherein the neutral main position is the position of the inside door handle, which is spring-biased, when no external force is exerted on the outside door handle to retract the latch; wherein in the neutral main position, the latchbolt is projected and wherein movement of the inside door handle from the first or second extent to the neutral main position leave the deadbolt in a position it had immediately before said movement.

The sliding spindle assembly can be incorporated into a legacy lockset, replacing existing mechanisms for operating the main spindle. For example, the sliding spindle assembly, which locks the lockset by decoupling the outside door handle from the main spindle, could replace a pre-existing assembly that locks the lockset by preventing rotation of the main spindle. By upgrading the lockset in this manner, existing hardware, such as the deadbolt, latchbolt, trim, and handles can continue to be used in the upgraded lockset.

### CONCLUSION

To summarize, a double latch lockset has been described that may be characterized as an inside door handle, an outside door handle, a latchbolt, a deadbolt, a main spindle and optionally also a clutch that are interconnected to provide several unique combinations of functions. Movement of the inside door handle in a first direction toward a first limit (e.g., lever down) simultaneously retracts both the latchbolt and the deadbolt. Movement of the inside door handle in a second direction toward a second limit (e.g., lever up) projects the deadbolt (and optionally also locks the latchbolt). Advantageously, return of the inside door handle from either the first or second limit to a neutral, default position intermediate of the first and second limits, where forces other than handle-actuating forces acting on the inside door handle are in equilibrium, does not change the position of the deadbolt last achieved at the first or second limit. Only when the inside door handle is pushed past the intermediate position, in a direction opposite the last achieved limit, does the deadbolt project or retract from its previously achieved position. This matter is fully described in U.S. patent application Ser. No. 15/393,679. However, unlike this application's revision of that disclosure, much of the original disclosure was not specific as to what constituted the “inside” or the “outside” (could have been either or both) or what the “first and second latchbolts” were made of (e.g., two conventional latchbolts, two conventional deadbolts, or one of each). Here, distinctions are emphasized between inside and outside lock and unlock functions.

The matter imported from U.S. patent application Ser. No. 17/093,534 introduced a more nuanced description of the operation of the outside handle. It described a specific embodiment in which movement of the outside door handle in a direction corresponding to the second direction, to a limit corresponding to the second limit (e.g., lever up), projects the deadbolt. Also, when the outside door handle is engaged—either permanently or via a clutch—to the outside door handle to the main spindle, and rotation is not otherwise blocked (e.g., by a traditional blocking lock), movement of the outside door handle in a direction (again in this example, lever down) that corresponds to the first direction retracts the latchbolt. In one embodiment, this action is performed without retracting the deadbolt. Of course, if the outside door handle is not engaged to the main spindle, or if the door handle is blocked from rotation in a particular direction from neutral, then the outside door handle is ineffective to retract either the deadbolt or the latchbolt. While in this embodiment, the deadbolt cannot be retracted by the outside door handle, the deadbolt can be retracted from the outside by turning a key or causing a similar action to occur mechanically through a key or touchpad input, a card swipe or proximal movement, or a wireless device that holds an appropriate credential. In a second embodiment, the outside door handle can retract the deadbolt provided that a key or credential applied from the outside has freed the deadbolt to be retracted by the outside door handle.

According to one implementation of an even more secure embodiment, a secondary linkage between the deadbolt and the latchbolt assembly causes the latchbolt to lock when the deadbolt projects. According to a second implementation of this secure embodiment, the secondary linkage operates in the opposite direction: movement of the inside or outside door handle in the second direction locks the latchbolt (assuming it is already projected) and a linkage between the latchbolt assembly causes the deadbolt to project when the latchbolt is locked. With either of these implementations, a break-in attempt has to overcome the blocking force of both the latchbolt and the deadbolt.

The matter imported from U.S. patent application Ser. No. 17/093,534 includes a detailed description of a sliding main spindle. And indeed, additional utilities can be gained by incorporating a sliding main spindle into the double latch lockset—namely, enabling conversion of the outside latch-retracting function between the outside handle being enabled to, and being disabled from, retracting the latchbolt. However, in the original set of claims that follows this disclosure, it will be seen that this function is given less emphasis than the functions for projecting and retracting the deadbolt. This emphasis, of course, is different in the claims of the Ser. No. 17/093,534 patent. This is why Applicant deemed it appropriate to present claims to these different characterizations of the invention(s) using separate patents.

Various changes may be made in the above details without departing from the spirit and scope of the double latch lockset as described. Various electronic actuators, switches, controllers, and other devices may be employed with the double latch lockset and its components. The resultant locksets may be fully or largely mechanical, electronic, or a combination thereof. Parts may be made of various materials as warranted, including metal, carbon, polymers, and composites.

Locksets are typically sold as an at least partially disassembled set. In order to cover these locksets in their sold form, assemblies and kits are envisioned comprised of various combinations of the novelties discussed in this specification, including, but not limited to a latchbolt, a deadbolt, a deadbolt, inside and/or outside actuators for the latches, drive assemblies, clutch assemblies, a locking rack and pinion, sliding actuator assemblies, latch cams, latch bolt assemblies, and a latch bolt tail. Many claims recite the elements of a lockset assembly in a broad form that encompasses a kit form in which the lockset is sold; however, the functions supported by the lockset assembly are described in reference to a completed assembly of the lockset.

Having thus described exemplary embodiments of the present invention, it should be noted that the disclosures contained in the drawings are exemplary only, and that various other alternatives, adaptations, and modifications may be made within the scope of the present invention. Accordingly, the present invention is not limited to the specific embodiments illustrated herein but is limited only by the following claims.

We claim:

1. A lockset comprising:
a latchbolt;
a deadbolt;
a main spindle;
a spindle-operated latch-retracting assembly; and
a primary deadbolt-operating link assembly;
a secondary deadbolt-operating link assembly;
wherein when the lockset is assembled:
the main spindle is coupled to inside and outside handles;
the spindle-operated latch-retracting assembly couples the latchbolt to the main spindle;
the primary deadbolt-operating link assembly couples the deadbolt to the inside handle;
the secondary deadbolt-operating link assembly couples the deadbolt to the outside handle;
the secondary deadbolt-operating link assembly transfers motion of the outside handle in a first direction to project the deadbolt;
thereafter, absent operation of the deadbolt, the secondary deadbolt-operating link assembly is disabled from transferring motion of the outside handle in any direction to retract the deadbolt.

2. The lockset of claim 1, wherein when the lockset is assembled:
each of the inside and outside handles are operable to be rotated, raised or lowered in a first direction and counter-rotated, lowered or raised in a second direction opposite the first direction; and
motion of the outside handle in the first direction acts to project the deadbolt.

3. The lockset of claim 2, wherein:
the primary deadbolt-operating link assembly transfers motion of the inside handle in the first direction to project the deadbolt and in the second direction to retract the deadbolt; and
the secondary deadbolt-operating link assembly transfers motion of the outside handle in the first direction to project the deadbolt.

4. The lockset of claim 2, wherein when the lockset is assembled, motion of the outside handle in the first direction also acts to lock the latchbolt.

5. The lockset of claim 2, wherein when the lockset is assembled:
in a first latchbolt state selectively implemented from an actuator on an inside door side of the lockset, motion of the outside handle in the second direction retracts the latchbolt; and
in a second latchbolt state selectively implemented from the inside door side of the lockset, motion of the outside handle in the second direction is inoperable to retract the latchbolt.

6. The lockset of claim 5, wherein the latchbolt is lockable and:
in the first latchbolt state, the latchbolt is unlocked, enabling motion of the outside handle in the second direction to retract the latchbolt;
in the second latchbolt state, the latchbolt is locked, disabling force on the outside handle in the second direction from retracting the latchbolt.

7. The lockset of claim 6, further comprising:
a tertiary linkage that transfers motion projecting the deadbolt to either a blocker that blocks the outside handle from rotating the main spindle to retract the latch, or to a clutch that decouples the outside handle from the main spindle when the outside handle is rotated in the second direction.
wherein motion on the outside handle in the first direction is transferred through the tertiary linkage to the blocker or coupling to prevent the outside handle from retracting the latchbolt.

8. The lockset of claim 2, wherein when the lockset is assembled:
the latchbolt is not lockable and a locked state for the lockset is achieved solely through the deadbolt; and
motion of the outside handle in the second direction operates to retract the latch whether the deadbolt is projected or retracted.

9. The lockset of claim 1, wherein when at least one of the inside and outside handles is a lever handle, the first, door-locking direction is up, and the second, door-unlocking direction is down.

10. The lockset of claim 1, wherein when the lockset is assembled, the secondary deadbolt-operating link assembly incorporates the primary deadbolt-operating link assembly and further comprises a handle coupler asymmetrically linked to a spindle driver to transfer outside door handle motion in the first direction to the spindle, and then through the primary deadbolt-operating link assembly, without transferring outside door handle motion in the second direction to the main spindle.

11. A lockset comprising:
a latchbolt;
a deadbolt;
a main spindle;
a spindle-operated latch-retracting assembly; and
a lock actuator configured with an unlocking maneuver to retract the deadbolt; and
a deadbolt-operating link assembly;
wherein when the lockset is assembled, the deadbolt-operating link assembly:
couples the deadbolt to the main spindle;
transfers motion of the outside handle in a first direction to project the deadbolt; and
is, after the deadbolt is projected and the outside handle is released, ineffective to transfer motion of the outside handle in the second direction to retract the deadbolt until the deadbolt is reset by action other than a mere movement of the outside handle.

12. The lockset of claim 11, wherein the lock actuator is a key cylinder, a touchpad, or a remotely accessible lock controller.

13. The lockset of claim 11, wherein the deadbolt-operating link assembly comprises a spindle-driven cam, a cam follower, and a deadbolt tailpiece driven by the cam follower.

14. The lockset of claim 13, wherein the deadbolt-operating link assembly further comprises a gear interposed between the cam follower and the deadbolt tailpiece.

15. The lockset of claim 14, wherein the deadbolt-operating link assembly further comprises an escapement element coupled to the cam follower, the escapement element interposed between the cam follower and the deadbolt tailpiece.

16. The lockset of claim 11, wherein the deadbolt-operating link assembly comprises gears that convert rotary motion of the main spindle into linear movement of the deadbolt.

17. The lockset of claim 11, wherein the deadbolt-operating link assembly comprises a lost motion mechanism comprising a cam operatively driven by the main spindle and a pivotally mounted cam follower that:
when the cam is rotated past a first threshold toward a first limit, the cam follower, when not already positioned at or near a first side of a pivot range, pivots toward the first side of the pivot range;
when the cam is counter-rotated past a second threshold toward the second limit, the cam follower, when not already positioned at or near a second side of the pivot range, pivots toward the second side of its pivot range; and
when the cam is rotating or counter-rotating from beyond the first threshold or the second threshold to between the first threshold and the second threshold, the cam follower remains in place;
wherein the first threshold is between the second threshold and the first limit, and the second threshold is between the first threshold and the second limit.

18. A lockset for a door that provides access from a first area to a second area, the lockset comprising:
a latchbolt;
a deadbolt;
a main spindle;
a spindle-operated latch-retracting assembly;
a lock actuator configured enable an unlocking maneuver to unlock the deadbolt; and
a link assembly; and
an outside-handle control link;
wherein when the lockset is assembled, the link assembly:
couples the deadbolt to the main spindle;
transfers motion of the outside handle a first direction to project the deadbolt and operate the outside-handle control link to prevent the outside handle from operating the latchbolt until a subsequent performance of the unlocking maneuver;
is configured to transfer motion of the outside handle in a second direction to retract the latchbolt; and
is, after the deadbolt is projected and until the deadbolt is retracted through means other than the outside handle, ineffective to transfer motion of the outside handle in the second direction to retract the deadbolt.

19. The lockset of claim 18, wherein the outside-handle control link moves between upward and lower bounds to convey motion from the link assembly to a coupling that either blocks the outside handle from rotating or that decouples the outside handle from the main spindle.

20. The lockset of claim 18, wherein the main spindle is operable to slide along its axial direction between first and second positions that couple and enable, and decouple and disable, an outside handle from retracting the latchbolt.
